(19) United States
(12) Patent Application Publication
(10) Pub. No.: US 2024/0411591 A1
(43) Pub. Date: Dec. 12, 2024

(54) METHODS AND SYSTEMS FOR PROCESSING ELECTRONIC COMMUNICATIONS

(71) Applicant: WorkStarr, Inc., Attleboro, MA (US)

(72) Inventor: Joseph D. Rando, Sharon, MA (US)

(73) Assignee: WorkStarr, Inc., Attleboro, MA (US)

(21) Appl. No.: 18/809,889

(22) Filed: Aug. 20, 2024

Related U.S. Application Data
(63) Continuation-in-part of application No. 17/030,868, filed on Sep. 24, 2020, now Pat. No. 12,079,743.
Application No. 17/030,868 is a continuation-in-part of application No. 16/519,134, filed on Jul. 23, 2019, now Pat. No. 10,817,782.

(51) Int. Cl. G06F 9/48; G06N 20/00

(52) U.S. Cl. CPC G06F 9/4881; G06N 20/00

(57) ABSTRACT

A system for processing electronic communications, the system including a server, a receiving module configured to receive a conversational response from a user device associated with at least a user and identify at least a request, a language processing module designed and configured to parse the at least a request for a task performance and retrieve at least a task performance datum, a task generator module designed and configured to generate at least a task performance data element as a function of the at least a task performance datum and a transmission source module designed and configured to: transmit the at least a task performance data element to the user device.

### RELATED APPLICATION DATA

This application is a continuation-in-part of Non-provisional application Ser. No. 17/030,868, filed on Sep. 24, 2020, now U.S. Pat. No. 12,079,743, issued on Sep. 3, 2024, and entitled “METHODS AND SYSTEMS FOR PROCESSING ELECTRONIC COMMUNICATIONS FOR A FOLDER,” which is a continuation-in-part of Non-provisional application Ser. No. 16/519,134, filed on Jul. 23, 2019, now U.S. Pat. No. 10,817,782, issued on Oct. 27, 2020, and entitled “METHODS AND SYSTEMS FOR TEXTUAL ANALYSIS OF TASK PERFORMANCES,” each of which are hereby incorporated by reference herein in their entirety.

### FIELD OF THE INVENTION

The present invention generally relates to the field of artificial intelligence. In particular, the present invention is directed to methods and systems for textual analysis of task performances.

### BACKGROUND

Automated textual analysis and correct usage of textual analysis can be challenging due to the quantity of text to be analyzed along with knowing what to do with text that has been analyzed. Incorrect use of text can lead to errors in transmission as well as cluttered information that takes up electronic space.

### SUMMARY OF THE DISCLOSURE

In an aspect, a system for processing electronic communications is described. The system includes at least a server, a data organizer operating on the at least one server, wherein the data organizer is designed and configured to categorize a plurality of tasks from the at least a server to one or more task categories, a task identification module operating on the at least one server, wherein the task identification module is designed and configured to identify one or more automatable tasks for each one of the one or more task categories using a task identifying machine-learning model trained with task identification training data, wherein the task identification training data comprises exemplary tasks correlated to exemplary automatable tasks, a task execution module operating on the at least a server, wherein the task execution module is designed and configured to execute the one or more automatable tasks as a function of the one or more task categories.

In an aspect, a method for processing electronic communications is described. The method includes receiving, from at least a server, a plurality of tasks, categorizing, using a data organizer operating on the at least one server, the plurality of tasks to one or more task categories, identifying, using a task identification module operating on the at least one server, one or more automatable tasks for each one of the one or more task categories using a task identifying machine-learning model trained with task identification training data, wherein the task identification training data comprises exemplary tasks correlated to exemplary automatable tasks and executing, using a task execution module operating on the at least one server, the one or more automatable tasks as a function of the one or more task categories.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a flow diagram illustrating an exemplary embodiment of a system for textual analysis of task performances;

FIG. 2 illustrates a block diagram of an exemplary embodiment of a task performance list;

FIG. 3 illustrates a block diagram of an exemplary embodiment of a language database;

FIG. 4 illustrates a block diagram of an exemplary embodiment of a task performance database;

FIG. 5 illustrates a block diagram of an exemplary embodiment of a data input field;

FIG. 6 illustrates a block diagram of an exemplary embodiment of a graphical user interface for a task detail;

FIGS. 7A-F illustrate screenshots of exemplary embodiments of a graphical user interface for digitally building task performances;

FIG. 8 illustrates a flow diagram of an exemplary embodiment of a method of textual analysis of task performances;

FIG. 9 illustrates a flow diagram of an exemplary embodiment of a system for processing electronic communications;

FIG. 10 illustrates a block diagram of an exemplary machine-learning module;

FIG. 11 illustrates a diagram of an exemplary neural network;

FIG. 12 illustrates a block diagram of an exemplary node in a neural network;

FIG. 13 illustrates a flow diagram of an exemplary embodiment of a method of processing electronic communications;

FIG. 14 illustrates a flow diagram of another exemplary embodiment of a method of processing electronic communications; and

FIG. 15 illustrates a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for processing electronic communications. In an embodiment, an electronic communication including a first communication datum such as an email or text message is utilized by a computing device to locate a folder relating to the electronic communication. A computing device generates a communication learner to output a response personalized to a user. The response is utilized to identify a second communication datum and update the folder to include the second communication datum.

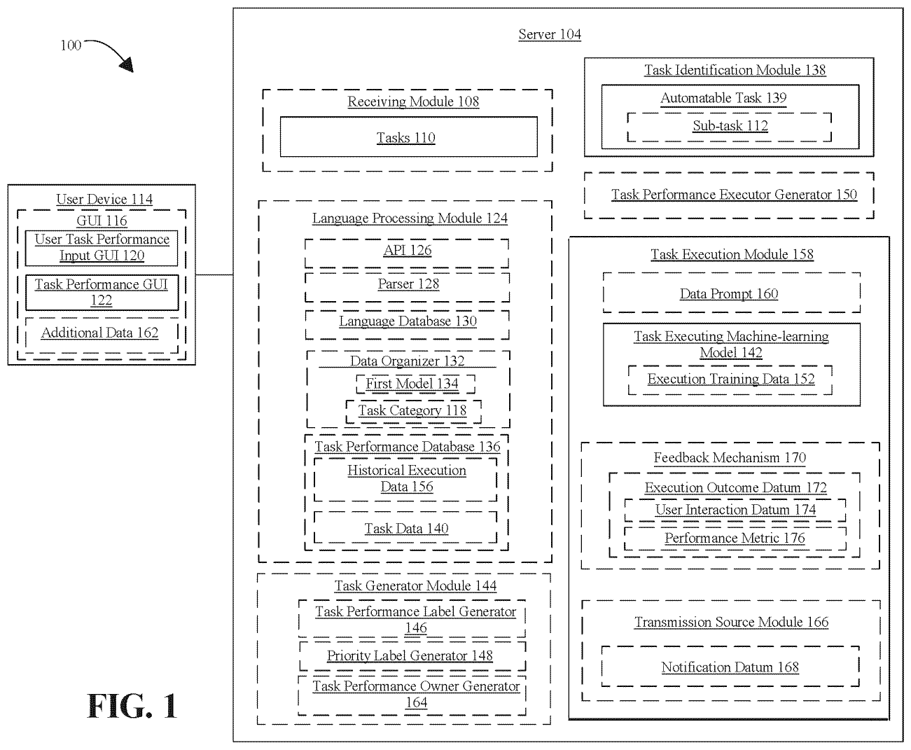

Referring now to the drawings, FIG. 1 illustrates an exemplary system 100 for textual analysis of task performances. System 100 includes at least a server 104. At least a server 104 may include any computing device as described herein, including without limitation a microcontroller, microprocessor, digital signal processor (DSP) and/or system on a chip (SoC). At least a server 104 may include, be included in, and/or communicate with a mobile device such as a mobile telephone or smartphone. At least a server 104 may include a single computing device operating independently, or may include two or more computing device operating in concert, in parallel, sequentially or the like; two or more computing devices may be included together in a single computing device or in two or more computing devices. At least a server 104 may communicate with other devices such as a user device as described in more detail below through a network interface. Network interface device may be utilized for connecting at least a server 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. At least a server 104 may include but is not limited to, for example, a at least a server 104 or cluster of computing devices in a first location and a second computing device or cluster of computing devices in a second location. At least a server 104 may include one or more computing devices dedicated to data storage, security, distribution of traffic for load balancing, and the like. At least a server 104 may distribute one or more computing tasks as described below across a plurality of computing devices of computing device, which may operate in parallel, in series, redundantly, or in any other manner used for distribution of tasks or memory between computing devices. At least a server 104 may be implemented using a “shared nothing” architecture in which data is cached at the worker, in an embodiment, this may enable scalability of system 100 and/or computing device.

With continued reference to FIG. 1, system 100 may include a receiving module 108 operating on the at least a server 104. Receiving module 108 may include any suitable hardware or software module. “Receiving module” is a module that receives any input or data. In an embodiment, receiving module 108 is designed and configured to receive at least a request for a task performance. “At least a request for a task performance” as used herein is a request to complete a task. In some embodiments, at least a request for a task performance may include description of any task that needs to be completed. In some embodiments, at least a request for a task performance may be associated with a plurality of tasks 110. For the purposes of this disclosure, a “task” is a work or activity that needs to be accomplished. A task 110 may include a personal task, work related task, community involvement task, and the like. For example, a task 110 may include a work-related task such as creating a rideable rocket toy for toddlers or surveying a rideable rocket toy market. In yet another non-limiting example, a task 110 may include a personal task such as obtaining a painter or setting up a weekly grocery allocation. A task 110 may include a community involvement task such as preparing foodstuffs for a local food pantry or organizing a charity softball tournament. A task 110 may relate to a hobby or leisure time activity such as an appointment with a personal trainer or participating in a spartan race. A task 110 may include a project and/or an action. A project as used herein includes a task that includes at least a sub-task 112. A “sub-task,” as used herein includes an element of a task that may be completed as part of a task. A sub-task 112 may include a task 110 broken down into smaller steps. In an embodiment, sub-tasks 112 may be broken down indefinitely into further sub-tasks. For example, a project such as creating a rideable rocket toy for toddlers may be broken down into sub-tasks 112 that may include several steps necessary to complete the project. This may include for example, developing three rideable rocket toys, choosing a rideable rocket toy, building a prototype rideable rocket toy, performing a rideable rocket toy market analysis, finalizing a rideable rocket toy rollout plan, and producing and a rideable rocket toy. In yet another non-limiting example, a task 110 may be created by John G. that is described as finding a new maintenance worker for an air-conditioner. In such an instance, John G. may break down the task 110 into sub-tasks 112 that include making a list of 3 companies, call companies to request a proposal, review proposals, and choose company. Sub-tasks 112 may be assigned to other people as described below. For example, John G. may assign a sub-task 112 such as to call workers to request proposal to his assistant, who may break that sub-task 112 down further into three different sub-tasks, one for each individual that John G.'s assistant calls. An action as used herein includes a task that does not contain any sub-task. An action may include, for example, a task such as buying new shoes, or ordering wood. In an embodiment, an action may be completed in one step and may not contain any smaller steps that need to be completed in order to complete the action. In an embodiment, an action may be transformed into a project when a sub-task has been added and/or assigned.

With continued reference to FIG. 1, at least a request for a task performance may be received from a user device 114. User device 114 may include an additional computing device, such as a mobile device, laptop, desktop computer, or the like. In an embodiment, user device 114 may be a computer and/or workstation operated by a user. User may include an individual who creates at least a request for a task performance and/or an individual who has been assigned at least a request for a task performance. At least a request for a task performance may be received from a conversational response. Conversational response as used herein may include any communication from at least a user. Conversational response may include for example, an email, message, textual documentation of a conversation, document, notes, explanation, description, and the like that contains a communication from at least a user. Conversational response may include a communication between two or more users, such as for example an email between two users or an email sent to a group of users such as an email thread between a knitting club group or a document containing input from three users in a shared location.

With continued reference to FIG. 1, user device 114 may include a graphical user interface (GUI 116), which may display information pertaining to at least a request for a task performance. GUI 116 may include without limitation a form or other graphical element having data entry fields, where a user may enter information describing one or more requests for a task performance as described in more detail below. GUI 116 may allow for interaction between a user and system 100 to display task performances which may be categorized in task categories 118 as described below in more detail. In some embodiments, GUI 116 may include user task performance input GUI 120, task performance GUI 122, and the like.

With continued reference to FIG. 1, GUI 116 may include user task performance input GUI 120 which may allow for and display user task performance inputs to allow a user to input information pertaining at least a request for a task performance. User task performance input GUI 120 may contain data entry fields that a user may enter specific information into such as for example by textual inputs and/or voice to text commands. For example, data entry fields may include without limitation a field containing a title whereby a user can enter a title describing at least a request for a task performance. For example, a title may include “Create rideable rocket toy for toddlers (RRS).” Data entry fields may include without limitation a field containing an assigned to option whereby a user can assign at least a request for a task performance to an individual. For example, a user may assign at least a request for a task performance to user and/or to another individual such as a coworker, family member or friend. In an embodiment, field containing an assigned to option may include a field where a user can enter an email address for the individual user is assigning at least a request for a task performance to. In an embodiment, as user types in a contact to assign to, a field may pop up and generate a list of previous contacts that a user has entered to make selection easier if a contact's information has been previously entered and/or assigned to. In such an instance, a user may select a contact from a pop-up field by highlighting a contact and selecting the contact. In an embodiment, assignments of tasks may be modified whereby a new assignee may be chosen such as when a task creator or assignor wishes to assign a task 110 and/or sub-task 112 to a new assignee. In an embodiment, a new task 110 may initially be assigned to the task creator as a default. The task creator may then assign task 110 to another person or assignee by typing the other person's name or email address in the assigned to field. In an embodiment, an assignee may receive an email containing a task assignment notice detailing the task 110 that has been assigned, while the task 110 will appear on the assignor's waiting for list and have a status of “pending approval.” In an embodiment, assigned to field may contain a drop-down menu selection containing connections and contacts who user may select to assign a task 110 to. In an embodiment, assigned to field may contain a customizable field whereby a user can begin to type information into the assigned to field and system 100 will match text that user enters with names, usernames, and/or email addresses of user's connections and contacts. User may then select a choice from the drop-down menu such as by highlighting a selection. In an embodiment, a user may assign a task 110 silently, whereby the assignee may not be notified of the task 110. A user may assign a task 110 silently such as when the user does not know the assignee's email address, a user wants to delay assigning a task 110 until a later date or time, or the user may feel uncomfortable about assigning a task 110 to a superior or thinks that it will reflect poorly on user or in bad form. In an embodiment, a silent assignment may be performed such as by checking a box that states, “do not notify assignee.” In such an instance, when an assignor unselects “do not notify assignee” then the assignee may be notified such as by email as described above.

With continued reference to FIG. 1, data entry fields may include without limitation a field containing an assigned by option whereby a user can enter information pertaining to who is assigning the at least a request for a task performance. For example, at least a request for a task performance may be assigned by user and/or by another. Data entry fields may include without limitation a field containing a relates to option whereby a user can enter information describing the field or task categories 118 that at least a request for a task performance relates to. “Task category” is a class of items having particular shared characteristics. For example, at least a request for a task performance that is titled “create rideable rocket toy for toddlers (RRS)” may relate to a task category 118 such as new products. In yet another non-limiting example, at least a request for a task performance that is titled “place a job ad on a job board” may relate to a task category 118 such as recruiting. Data entry fields may include without limitation a field containing a start date which may include information as to when at least a request for a task performance may be initiated. For example, a start date may be listed as today if it will be started right away or may contain a future date such as next week, next month, or some specific date in the future. Data entry fields may include without limitation a field containing due date which may include information as to when at least a request for a task performance must be completed by. For example, a due date may list a specific date by which at least a request for a task performance must be completed by, such as October 15^{th}. In yet another non-limiting example, a due date may list a date in terms of weeks, months, and/or years by which at least a request for a task performance must be completed by, such as in 7 days, in 14 days, in 2 weeks, and the like. Data entry field may include without limitation a field containing a description, which may include information describing details and features of at least a request for a task performance. For example, at least a request for a task performance such as to “define rideable rocket toy requirements” may include a description such as “define the requirements for the rideable rocket toy to maximize market share in the toddler market.” In an embodiment, data entry fields may be completed by a voice memo that may capture a user's inputs for certain data fields. For example, a user who is driving a motor vehicle may complete data entry fields through a voice to text option contained within GUI 116.

With continued reference to FIG. 1, data entry fields may include without limitation, at least a field containing information unique to each individual user of system 100. This may allow for actions and/or projects specific to each user to be displayed on user's own action list and/or task performance list as described in more detail below. For example, data entry field may include without limitation a field that prompts each user to enter user's first name and last name. Data entry field may include without limitation a field that allows for a user to create a unique username. Data entry field may include without limitation a field that allows for a user to create a password that may be associated with user's unique username. In an embodiment user may be prompted to enter password a second time. Data entry field may include without limitation demographic information pertaining to a user such as user email address, user mobile phone number, user other phone numbers such as home, office and the like, user address, and/or user company name. Data entry field may include without limitation a field that allows a user to optionally upload a photo of themselves. Data entry field may include without limitation a field that allows a user to enter skills that they possess such as for example punctuality, organized, diligence, leadership, basic computer skills, oral speaking skills, and the like.

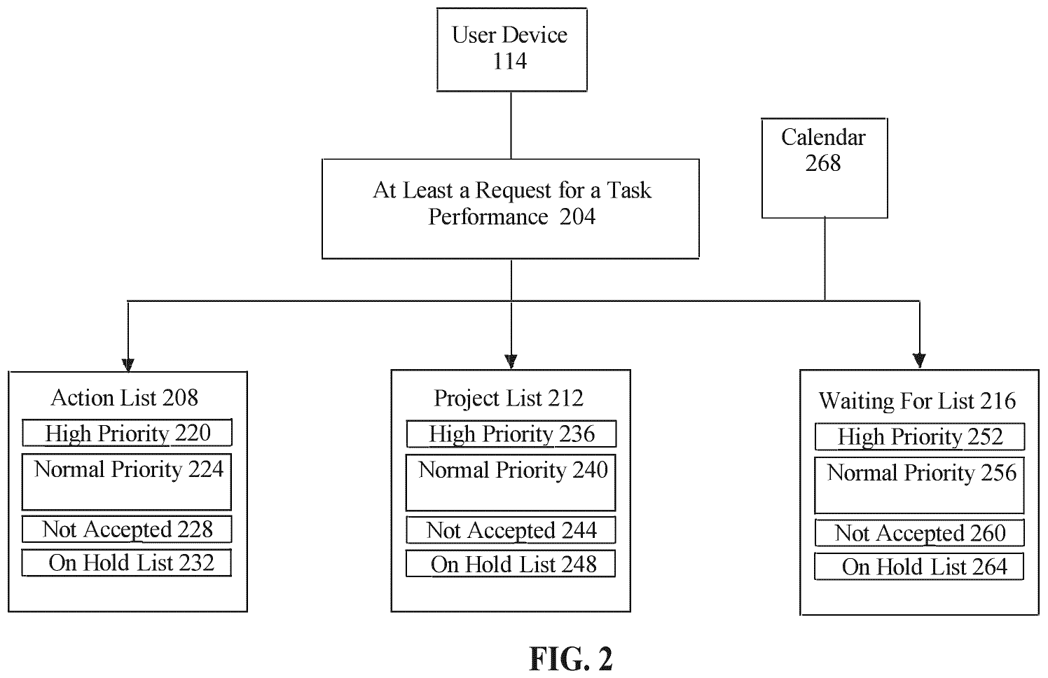

With continued reference to FIG. 1, GUI 116 may contain task performance GUI 122. Task performance GUI 122 may display task performances that a user needs to complete. In an embodiment, task performances or tasks 110 may be grouped into task categories 118, organizing task performances as a function of if a task performance contains sub-tasks 112 or not and/or if a task performance will be performed by user or another person. In an embodiment, task performances may be organized onto lists such as those generated by language processing module as described in more detail below. This may include for example, an action list, a project list, and/or a waiting for list as described in more detail below and in reference to FIG. 2.

With continued reference to FIG. 1, at least a request for a task performance may include at least a task performance file. Task performance file as used herein, includes any and all information pertaining to at least a request for a task performance. Information pertaining to at least a request for a task performance may include, for example, discussion threads between users pertaining to the at least a request for a task performance. Information may include messages sent between users or messages that user may transmit to himself or herself pertaining to the at least a request for a task performance. Information may include files pertaining to the at least a request for a task performance. For example, at least a request for a task performance such as painting user's fence may include a file containing price estimates from three different painters. Information may include notes pertaining to the at least a request for a task performance. Notes may include for example user's thoughts and reflections after interviewing three different painters to paint user's house. Information may include appointments pertaining to the at least a request for a task performance. For example, at least a request for a task performance such as finding a landscaper to mow user's lawn may include appointments user has scheduled with different landscaping companies. In yet another non-limiting example, appointments may include appointments user has had or will have with other users who may participate with the at least a request for a task performance. For example, at least a request for a task performance such as recruiting a new hire at a company may include appointments a user has already had with potential job applicants as well as future appointments user may have with other potential job applicants. In such an instance, appointments with other co-workers in addition to user may be contained within appointments section, such as when a potential job applicant may meet with three different individuals within the company.

With continued reference to FIG. 1, system 100 includes a language processing module 124 operating on the at least a server. Language processing module 124 may include any suitable hardware or software module. Language processing module 124 may be designed and configured to parse the at least a request for a task performance and retrieve at least a task performance datum related to a plurality of tasks 110, categorize the at least a request for a task performance to at least a task performance list, and assign the at least a request for a task performance to at least a task performance owner. Language processing module 124 may be configured to extract from at least a request for a task performance one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols. Textual data may be parsed into segments, which may include a simple word (sequence of letters separated by whitespace) or more generally a sequence of characters as described previously. The term segments as used herein refers to any smaller, individual groupings of text from a larger source of text; segments may be broken up by word, pair of words, sentence, or other delimitation. These segments may in turn be parsed in various ways. Textual data may be parsed into words or sequences of words, which may be considered words as well. Textual data may be parsed into “n-grams”, where all sequences of n consecutive characters are considered. Any or all possible sequences of segments or words may be stored as “chains”, for example for use as a Markov chain or Hidden Markov Model.

With continued reference to FIG. 1, language processing module 124 may parse at least a request for a task performance to retrieve a task performance datum. A “task performance datum” as used herein, is data element related to one more keywords pertaining to at least a request for a task performance. Keywords may include relevant information relating to the at least a request for a task performance (e.g., a plurality of tasks 110) and may include for example information pertaining to a category of at least a request for a task performance and/or at least a task performance owner. In some embodiments, task category 118 may include for example information pertaining to a task performance list, such as whether at least a request for a task performance may be placed on action list, project list, and/or waiting for list. Category may include for example information pertaining to one or more of the data entry fields as described above such as relates to data field, description field, and the like. Keywords may be extracted by language processing module 124 by creating associations between one or more words extracted from at least a request for a task performance including without limitation mathematical associations, between such words, and/or associations of extracted words with categories of task performances. For example, associations between at least a request for a task performance that includes an entry such as “schedule follow-up with Larry” may be associated with a category of task performance such as work because Larry is a colleague from work. Associations between extracted keywords may include mathematical associations, including without limitation statistical correlations between keywords, at least a request for a task performance, and/or categories of task performances. Statistical correlations and/or mathematical associations may include probabilistic formulas or relationships indicating, for instance, a likelihood that a given extracted word indicates a given category (e.g., task category 118) of task performance, and/or a given task performance owner. As a further example, statistical correlations and/or mathematical associations may include probabilistic formulas or relationships indicating a positive and/or negative association between a keyword and/or a category of at least a task performance and/or at least a task performance owner; positive or negative indication may include an indication that a given document is or is not indicating a category of task performance, and/or that a certain individual is or is not a task performance owner. For instance, and without limitation, a negative indication may be determined from a phrase such as “John is not allowed to set up interviews with new job candidates,” whereas a positive indication may be determined from a phrase such as “Sally is allowed to set up interviews with new job candidates,” as an illustrative example; whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in a memory located on the at least a server.

With continued reference to FIG. 1, language processing module 124 may contain application programming interface 126 (API). API 126 may contain communication protocols that may specify communications between, for example, between language processing module 124 and other modules contained within server 104 and/or communications with GUI 116. Persons skilled in the art will appreciate that the components of API 126 may not be physically resident within server 104 but may also be accessed through local or wide networks.

With continued reference to FIG. 1, language processing module 124 may contain parser 128. Parser 128 may parse at least a request for a task performance to retrieve a task performance datum as described in more detail above. Parser 128 may parse content of at least a request for a task performance received from a user device 114. Parser 128 may parse content of a conversational response to determine relevant portions to retrieve a task performance datum. Conversational response may include any communication from at least a user. Conversational response may include for example, an email, message, textual documentation of a conversation, document, notes, explanation, description, and the like that contains a communication from at least a user. In an embodiment, conversational response may include a communication from a plurality of users such as for example an email thread involving six different participants. In such an instance, parser 128 may parse the email thread containing messages from the six different participants to retrieve a task performance datum. In an embodiment, parser 128 may parse at least a request for a task performance containing an input from user device 114 and a conversational response.

Still referring to FIG. 1, language processing module 124 may generate the language processing model by any suitable method, including without limitation a natural language processing classification algorithm; language processing model may include a natural language process classification model that enumerates and/or derives statistical relationships between input term and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word keyword, a given relationship of such keywords to categories (e.g., task category 118) of task performances, and/or a task performance owner. There may be a finite number of keywords, a given relationship of such keywords to categories of task performances, and/or a given task owner to which an extracted word may pertain; an HMM inference algorithm, such as the forward-backward algorithm or the Viterbi algorithm, may be used to estimate the most likely discrete state given a word or sequence of words. Language processing module 124 may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module 124 may contain language database 130. In an embodiment, parser 128 may access language database 130 to determine the meaning of at least a request for a task performance. Language database 130 may contain a glossary table that may contain information such as contextual meaning of at least a request for a task performance. Language database 130 may contain a voice recognition table that may identify spoken commands such as when a user interfaces with GUI 116 through a voice to text option. Language database 130 may contain a natural language table that may contain information pertaining to meaning of common language terms used in general conversations.

With continued reference to FIG. 1, language processing module 124 may categorize the at least a request for a task performance to at least a task performance list and assign the at least a task performance to at least a task performance owner. At least a request for a task performance may be categorized as a function of at least a task performance datum. In an embodiment, task 110 may be categorized utilizing data organizer 132 as described in more detail below. In such an instance, data organizer 132 may categorize task performances utilizing machine-learning and generating machine-learning models, including any of the machine-learning models as described herein. Task performance list may include groupings of requests for a task performance based on common shared characteristics. Task performance list may include an action list. Action list may include a grouping of task performances that includes only action items. Action items may include actions that do not contain sub-tasks 112. Action items may include for example, a one-time action that does not contain sub-tasks such as ordering a pair of shoes, buying airline tickets to France, placing a request for dinner, and the like. In an embodiment, an action may be transformed into a project when a sub-task is added to an action, whether by a user and/or assigned by someone else. For example, an action such as buying a pair of shoes may be transformed into a project when a sub-task such as researching best evening dress shoes is added to the action. In yet another non-limiting example, an action such as schedule a date for Frank's retirement party may be transformed into a project when a user is assigned a sub-task such as call Mary and call Joe to see when they are available for Frank's retirement party.

With continued reference to FIG. 1, action items may contain data entry fields that allow a user who has created an action to enter details pertaining to an action. In an embodiment, action list may include an effort to complete data field that may contain information describing by a user the amount of time they estimate it will take to complete an action. In an embedment, an action detail data field may include a “mark complete” option that a user may mark to signal an action item as complete.

With continued reference to FIG. 1, task performance list may include a project list. Project list may include a grouping of task performances that includes only projects. Projects may include actions that do contain sub-tasks. In an embodiment, a project may be transformed into an action such as when a project contains only one sub-task that is either eliminated and/or completed. Project items may include a list of all current projects pertaining to a user such as a project for buying a new car, a project for organizing a dinner party, and a project for interviewing a new assistant manager at work. Projects may contain sub-tasks that may be constantly updated and/or broken down into further sub-tasks. In an embodiment, a sub-task may be broken down into a subsequent sub-task that may be further broken down into a subsequent sub-task. For example, a sub-task such as mowing the lawn may be broken down into a subsequent sub-task such as trim the hedges which may be broken down into a subsequent sub-task such as purchase new hedging equipment which may be further broken down into a sub-task such as take a trip to Home Depot. In yet another embodiment, a sub-task such as cleaning out the refrigerator may be broken down into a subsequent sub-task such as buy cleaning supplies which may be broken down into a subsequent sub-task such as buy bleach and ammonia. In an embodiment, a sub-task may be broken down indefinitely. Task performance list may include a waiting for list. Waiting for list may include a list of tasks assigned by a user to other people. For example, a sub-task such as purchase napkins that user has assigned to user's spouse, may be included on waiting for list. In yet another non-limiting example, an action titled “Purchase new computer” that a user has assigned to user's paralegal may be included on waiting list.

With continued reference to FIG. 1, task performance list may be customized to a user. For example, a task performance list containing action list may be customized to action items that user needs to perform. In such an instance, project list may contain projects that user needs to perform and waiting for list may include tasks assigned by the user to other people. For example, an action such as making a phone call that the user has assigned to another person would appear on the user's task performance list under the waiting for list. In such an instance, the person who has been assigned the action to make the phone call would see the phone call on that person's action list. Action list customized to user may contain actions assigned by user and/or another person. Action list customized to user contains only actions assigned to user. For example, an action that user's spouse will perform will not be contained on user's own individual action list. Action list customized to user contains only actions that do not contain any sub-tasks. Projects list customized to user may contain projects assigned by user and/or another person. Project list customized to user contains only projects assigned to user. For example, a project that user's secretary person will not be contained on user's own individual project list while a project that user will perform will be contained on user's individual project list. In an embodiment, user's project list may contain a mix of projects that may pertain to different areas of user's life. For example, user's project list may contain a personal project such as remodeling user's kitchen, a work-related project such as hiring a new secretary, and a leisure time activity such as find new team member for user's recreational rugby team. User's project list will contain sub-tasks relating to each project. Waiting for list customized to user contains tasks assigned by user. Waiting for list customized to user contains tasks assigned to another person. Waiting for list customized to user may contain actions and/or projects and may or may not contain sub-tasks.

With continued reference to FIG. 1, task performance list including action list, project list, and/or waiting for list may contain data entry fields containing information specific and/or unique to each task. In an embodiment, certain data entry fields may be required, whereby a user must enter information in a specific data entry field. Data entry fields may include without limitation a task identifier that uniquely identifies each task. Data entry fields may include without limitation a task name. Task name may be searchable by a user who may be looking for a specific task.

With continued reference to FIG. 1, data entry field may include without limitation a created by field that may contain information as to who initially created the task. Data entry field may include without limitation a task creation date, which may include information as to what date the task was initially created. Data entry field may include without limitation an assigned by field, which may include information as to what user assigned the task, who may be known as the assignor. Data entry field may include without limitation assigned to field, which may include information as to whom the task is assigned to, and this person may also be known as the assignee. In an embodiment, a task may by default be assigned to the task creator or user, who must then choose to assign the task to another. Data entry field may include without limitation a task assigned date field, which may include information as to the date the task was assigned to another person by the task creator and/or assignor. In an embodiment, task assigned date field may be the same as the task creation date such as for example when a task is created and then assigned on the same day. In an embodiment, task assigned date field may be different than the task creation date such as for example when a task is created on a different day than the day the task is assigned. Data entry field may include without limitation start date, which may include information as to when work should commence on the task. In an embodiment, the task may be shown to be on hold before the start date. For example, a task having a start date two weeks in the future will be shown to be on hold for the two weeks until the actual start date occurs. In an embodiment, a user may modify a start date, even if a task has already been assigned. Data entry field may include without limitation due date field, which may include information as to the date when the task must be completed by. In an embodiment, user and/or task assignor may change a due date even if the task has been assigned. In an embodiment, another person and/or assignee who may wish to change due date set by an assignor may request a due date change to the assignor in order to get the date changed. Data entry field may include without limitation date completed field, which may include information as to the date that the assignee marks a task as completed. Data entry field may include without limitation date approved field, which may include information as to the date that the assignor may give approval to the task. In an embodiment, when a task has not been assigned such that the assignee and assignor are the same user, then the date completed, and the date approved will contain the same information. Data entry field may include without limitation relates to field, which may include information describing a physical object or other item that the task relates to. In an embodiment, relates to field may include a description of an item that a task may relate to such as a house, code module, vehicle, building and the like. In an embodiment, relates to field may include a description of a non-physical item that a task may relate to such as a personal goal, objective, mission, and the like. Data entry field may include without limitation sub-tasks field, which may include information describing a sub-task as a part of a project. In an embodiment, a sub-task may be optional. Data entry field may include without limitation description field, which may include information containing information that a task creator may enter to describe a task. In an embodiment, description field may be a required field and may be modified by creator and/or assignor of a task. Data entry field may include without limitation messages field, which May include message and/or emails compiled that relate to the task. Data entry field may include without limitation files field, which may include files relating to the task. For example, a task such as obtaining 3 price estimates for a kitchen remodel may contain a file containing the 3 separate price estimates. In yet another non-limiting example, a task such as interview candidates for San Francisco position may include several files with each file containing application materials for each specific candidate. Data entry field may include without limitation shared with field, which may include information pertaining to who a task has been shared with. Data entry field may include without limitation location field, which may include information describing where the task may be performed. For example, location field may include data entries such as work, home, driving, phone, and the like. In an embodiment, location may be selected by a user from a drop-down menu selection that a user may highlight the appropriate location. Location drop-down menu selection may be unique to each user and locations may be added and subtracted from the drop-down menu by a user. In an embodiment, a task that has been assigned to another user may not contain a data entry in the location field, so that the user who will perform the task will select from user's own location list where the task will be performed.

With continued reference to FIG. 1, data entry field may include without limitation effort to complete field, which may include information describing how long the task will take to be completed. In an embodiment, a task that contains sub-tasks such as a project, will have values for the time to complete sub-tasks added up from each individual sub-task and added into the total time to complete the project. In an embodiment, a task containing sub-tasks such as a project may calculate effort to complete by adding and totaling effort to complete for all sub-tasks. Effort to complete field may also contain without limitation an effort units field, which may contain information reflecting the units such as minutes or hours necessary to complete a task. In an embodiment, sub-tasks that may be part of a project may not contain a value but will be added into the total effort units to complete the project that the sub-tasks are a part of. For example, a project containing 3 separate sub-tasks that will each take 1 hour to complete will have an effort to complete of 3 hours with the effort units reflected as hours. In yet another non-limiting example, a project containing two sub-tasks that will each take 10 minutes to complete will have an effort to complete of 20 minutes with the effort units reflected as minutes. Data entry field may include without limitation appointments field, which may include information describing tasks that take place at a specific time and may have more than one assignee as described in more detail below. Data entry field may include without limitation recurrence field, which may include tasks that are performed on a recurring basis. For example, a task such as driving children to piano lessons may occur on a recurring basis such as every Thursday afternoon, and as such recurrence field may contain information reflecting this. Data entry field may include without limitation private notes field, which may include information relating to a task that are created by either a task creator and/or assignee and which may only be viewed by the task creator and/or assignee. In an embodiment, a user such as a task creator and/or assignee who creates a private note may share information contained within the private note only if the task creator and/or assignee who created the private note grants such permission. Data entry field may include without limitation priority field, which may include information pertaining to the importance of a task. In an embodiment, priority field may include an entry such as normal priority such as when the task is not associated with additional importance. In an embodiment, priority field may include an entry such as high priority such as when a task is associated with additional importance. In an embodiment, assignor and assignee may have a different value for the priority field. Data entry field may include without limitation hold/release field, which may contain information as to whether or not a task has commenced. For example, hold/release field may contain an entry such as “on hold” if a task has not started yet. In an embodiment, an assignor may release a task before it leaves an “on hold” status.

With continued reference to FIG. 1, data entry field may include without limitation status field, which may include information reflecting whether an assignee has accepted and/or rejected a task from an assignor. In an embodiment, a task that has been accepted by an assignee may contain an entry in status field of “accepted” while a task that has been rejected by an assignee may contain an entry in status field of “rejected.” Status field may also contain information describing status of tasks and sub-tasks. For example, when all sub-tasks for a project are completed the status of the project may contain an entry such as “sub-tasks complete.” In an embodiment, an assignee may make a task as complete when assignee completes a task. For example, a user may assign a task such as obtaining a price quote on new furniture to user's assistant, who may update the status of the task to complete after user's assistant has obtained price quote. In an embodiment, a user such as an assignor who has created a task can enter text into an approved field to reflect that a task has been completed and that assignor has granted approval on the task. Status field may be updated to reflect status throughout start date and due date. For example, a task may be labeled as “on track” such as when the task has not been given approval by task owner and it is not due or late. In yet another non-limiting example, a task may be labeled as “due” such as when the due date has closed, such as on the day of the established due date. In yet another non-limiting example, a task may be labeled as “late” when the due date has passed for a task.

With continued reference to FIG. 1, language processing module 124 may assign at least a request to at least a task performance owner. In an embodiment, at least a request for a task performance may be initially assigned to the user that created the at least a request for at ask performance. For example, a user who creates at least a request for a task performance such as rake the leaves may be initially assigned to user as task performance owner. User may then assign the at least a request for a task performance to another individual, known as assignee. Assignee may be a friend, family member, co-worker, colleague, other user of system 100, and the like. In an embodiment, assignee may not be a user of system 100 and may be contacted through an email notification. For example, a user who wishes to assign at least a request for a task performance to user's sister who does not participate in system 100 may email user's sister the at least a request for a task performance. In such an instance, an email notification sent to a user who does not participate in system 100 may contain a brief description of the at least a request for a task performance along with information about the at least a request for a task performance. In such an instance, there may be a link that a user may click on to enable a screen that may bring a non-user of system 100 to a screen for non-users. In an embodiment, an email sent to a nonuser of system 100 may contain a messaging link which may enable a nonuser to communicate with assignor of at least a request for a task performance. For example, a nonuser may wish to communicate with assignor to collect more details and questions concerning at least a request for a task performance. In an embodiment, an assignee who accepts at least a request for a task performance may form a connection with assignor who assigned the at least a request for a task performance which may be documented within a data field contained within the at least a request for a task performance. For example, a user who assigns at least a request for a task description such as obtain price quote on new shutters to user's secretary, may appear within the at least a request for a task description to obtain price quote on new shutters once user's secretary has accepted. In such an instance, the connection between user and user's secretary may be documented within notes section of the at least a request for a task description as described above in more detail. In such an instance, the at least a request for a task description containing a task to obtain a price quote on new shutters may appear on user's waiting for list and may appear on user's secretary's action list.

With continued reference to FIG. 1, language processing module 124 may determine that the at least a request for a task performance includes a task performance identifier and generates at least a task performance data element as a function of the task performance identifier. Task performance identifier as used herein may include any information containing information relating to one or more data entry fields describing at least a request for a task performance. Data entry fields may include any of the data entry fields as described above in more detail. Data entry fields may include information containing detailed information about at least a request for a task performance. This may include, for example, a description of when a task performance may need to be started or when the task performance needs to be completed. Language processing module 124 may extract task performance identifier using any of the methodologies as described above. This may include for example, generating algorithms and utilizing machine-learning processes as described in more detail below. Language processing module 124 may generate at least a task performance data element utilizing the task performance identifier. Task performance data element as used herein, includes a task description containing a task performance list label and a priority label. Task 110 may include any job that needs to be completed. Job may include any item that a user needs to complete whether relating to a user's personal life, family life, home life, work life, free time activity like, community life, and the like. Job may relate to any facet of a user's life. For example, a job may include a personal job such as mowing user's lawn or a work job such as organizing files for review. In an embodiment, jobs may overlap between different aspects of a user's life. In an embodiment, task performance data element may contain additional information such as a task performance owner.

With continued reference to FIG. 1, system 100 includes a data organizer 132. For the purposes of this disclosure, a “data organizer” is a computational model or system designed to categorize a plurality of tasks. Data organizer 132 is designed and configured to categorize a plurality of tasks 110 to one or more task categories 118. In some embodiments, language processing module 124 may include a data organizer 132 configured to generate at least a task performance data element as a function of the task performance identifier. Data organizer 132 may include any hardware and/or software module. Data organizer 132 may be designed and configured to generate outputs using machine learning processes. A machine learning process is a process that automatedly uses a body of data known as “training data” and/or a “training set” to generate an algorithm that will be performed by a computing device/module to produce outputs given data provided as inputs; this is in contrast to a non-machine learning software program where the commands to be executed are determined in advance by a user and written in a programming language. In some embodiments, data organizer 132 may be configured to receive a conversational response from a user device associated with at least a user and identify, using a language processing module, at least a request for a task performance as a function of the conversational response, wherein the at least a request for a task performance is associated with the plurality of tasks. This may be consistent with receiving module 108 described above.

With continued reference to FIG. 1, data organizer 132 may be designed and configured to generate at least a task performance data element by creating at least a first machine-learning model 134 relating inputs such as a task performance datum and/or a task performance identifier to outputs that may include at least a task performance data element, such as by using a first training set. Such models may include without limitation model developed using linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that May occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 1, at least a server 104, language processing module 124, and/or data organizer 132 may be configured to receive training data to generate at least a first machine-learning model 134. Training data, as used herein, is data containing correlation that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), enabling processes or devices to detect categories of data.

Alternatively, or additionally, and still referring to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name and/or a description of a medical condition or therapy may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below. In an embodiment, first training set may include a plurality of first data entries, each first data entry including at least a task performance identifier and at least a correlated task performance data element. Such training data may be utilized by data organizer 132 to generate outputs that include task performance data elements as a function of receiving at least a task performance identifier utilizing the training data and the first machine-learning model 134. In an embodiment, data organizer 132 may utilize training data to generate outputs such as categorizing requests for task performances or plurality of tasks 110. In an embodiment, data organizer 132 may receive training data including at least a request for task performances and a correlated task performance list. Data organizer 132 may utilize at least a request for a task performance and associated training data to generate a machine-learning model to assign tasks to task performance lists. Data describing requests for task performances that have been categorized to task performance list may be utilized to update outputs generated by data organizer 132.

Continuing to refer to FIG. 1, machine-learning algorithm used to generate first machine-learning model 134 may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Still referring to FIG. 1, language processing module 124 may generate task performance data element output using alternatively or additional artificial intelligence methods, including without limitation by creating an artificial neural network, such as a convolutional neural network comprising an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. This network may be trained using first training set; the trained network may then be used to apply detected relationships between elements of task performance identifiers and/or task performance datums and task performance data elements.

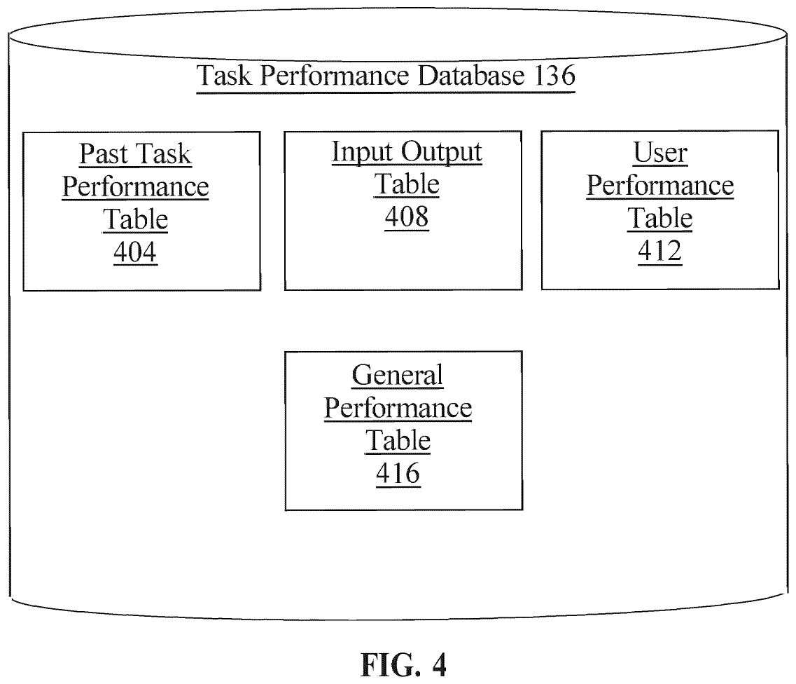

With continued reference to FIG. 1, language processing module 124 may contain task performance database 136. Language processing module 124 may extract at least a datum from task performance database 136 using the at least a request for a task performance and generate at least a task performance data element as a function of the at least a datum. Task performance database 136 may include tables containing information relating to a task performance data element as described in more detail below in reference to FIG. 4. In an embodiment, language processing module 124 may extract at least a datum from language database 130.

With continued reference to FIG. 1, system 100 includes a task identification module 138 operating on at least one server 104. A “task identification module” is a computational model or system that identifies one or more automatable tasks from a plurality of tasks. For the purposes of this disclosure, an “automatable task” is a task that can be automatically executed by a system 100. Task identification module 138 is configured to identify automatable tasks 139 based on task data 140 retrieved from a task performance database 136. In a non-limiting example, task data 140 may be retrieved as a function of task performance datum from task performance database 136. For example, and without limitation, task data 140 may be retrieved from task performance database 136 using a keyword that is related to tasks 110. For the purposes of this disclosure, “task data” is data related to information related to a plurality of tasks. As a non-limiting example, task data 140 may include communication records on file such as emails and chat histories, current task assignment, user schedules, and/or the like. In some embodiments, task data 140 may include task performance file as described above. In some embodiments, task data 140 may be analyzed using language processing module 124, and the like. In some embodiments, task identification module 138 may include a rule-based engine or a task identifying machine-learning model trained using task identification training data. In some embodiments, task identification training data may include exemplary task data and exemplary tasks correlated to exemplary automatable tasks. In some embodiments, task identifying machine-learning model may associate task data 140 and tasks 110 to determine automatable task 139. In a non-limiting illustrative example, task data 140 may include an employee's email communications related to scheduling meetings and user's schedule and task 110 may include setting up a schedule for a meeting, then task executing machine-learning model 142 may find that task 110 can be automatically executed based on the email communication and user's schedule and determine the task 110 as automatable task 139. In some embodiments, machine-learning model and training data may be any machine-learning models and training data described in this disclosure. In another non-limiting illustrative example, task identification module 138 may analyze emails from task performance database 136 and to identify routine tasks such as responding to standard queries, scheduling meetings, and sorting emails into folders. By recognizing patterns in the emails, such as common phrases in standard queries or frequent scheduling requests, task identification module 138 may determine these tasks 110 that they can be automated.

With continued reference to FIG. 1, in some embodiments, system 100 may include a task performance database 136. As used in this disclosure, “task performance database” is a data structure configured to store data associated with a plurality of tasks. In one or more embodiments, task performance database 136 may include inputted or calculated information and datum related to a task 110 and a user related to task 110. For the purposes of this disclosure, a “user” is any person or individual that is using or has used a system. In some embodiments, a datum history may be stored in task performance database 136. As a non-limiting example, the datum history may include real-time and/or previous inputted data related to the task 110. As a non-limiting example, task performance database 136 may include instructions from a user, who may be an expert user, a past user in embodiments disclosed herein, or the like, where the instructions may include examples of the data related to task 110.

With continued reference to FIG. 1, in some embodiments, server 104 may be communicatively connected with task performance database 136. For example, and without limitation, in some cases, task performance database 136 may be local to server 104. In another example, and without limitation, task performance database 136 may be remote to server 104 and communicative with server 104 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure server 104 connect directly, dynamically, and non-hierarchically to as many other computing devices as possible. A “network topology” as used in this disclosure is an arrangement of elements of a communication network. The network may use an immutable sequential listing to securely store task performance database 136. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, task performance database 136 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, system 100 may include a task generator module 144 operating on at least a server 104. Task generator module 144 may include any suitable hardware or software module. Task generator module 144 may be designed and configured to generate at least a task performance data element as a function of the at least a task performance datum and containing a task performance list label and a priority label. Task performance list label may include a label including reference to a task performance list that the at least a request for a task performance may be assigned to. Task performance list label may include any of the task performance lists as described above including action list, project list, and/or waiting for list. Details describing task performance list are described in more detail below in reference to FIG. 2. Priority label may include a label describing information pertaining to importance of at least a request for a task performance. Priority label may include any of the labels as described above including a label such as normal when at least a request for a task performance contains no additional importance or high such as when at least a request for a task performance contains additional importance.

With continued reference to FIG. 1, task generator module 144 may include task performance label generator 146. Task performance label generator 146 may generate list label indicating task performance list that request for at least a task performance may be assigned to. Task performance label generator 146 may generate a label such as action when at least a request for a task performance may be assigned to action list. Task performance label generator 146 may generate a label such as project when at least a request for a task performance may be assigned to project list. Task performance label generator 146 may generate a label such as waiting for when at least a request for a task performance may be assigned to waiting for list. In an embodiment, task performance label generator 146 may generate label with information provided by language processing module 124 such as parser 128 and/or language database 130.

Continuing to refer to FIG. 1, task generator module 144 may include priority label generator 148. Priority label generator 148 may generate priority label regarding priority of at least a request for a task performance. Priority label generator 148 may generate a label such as normal when at least a request for a task performance contains no additional importance. Priority label generator 148 may generate a label such as high when at least a request for a task performance contains additional importance. In an embodiment, task performance label generator 146 may generate label with information provided by language processing module 124 such as parser 128 and/or language database 130.

With continued reference to FIG. 1, system 100 may include a task performance executor generator 150 operating on at least a server 104. “Task performance executor generator,” as used herein, is a computational model or system designed and configured to assign each of one or more automatable tasks to one task executing machine-learning model of a plurality of task executing machine-learning models. In some embodiments, task performance executor generator 150 may be configured to load one or more automatable tasks 139 and distribute each of one or more automatable tasks 139 to one task executing machine-learning model 142 of a plurality of task executing machine-learning models 142 as a function of one or more task categories 118. As a non-limiting example, one or more automatable tasks 139 may be loaded in queue e.g., priority queue that distribute/assign task based on the priority. For example, and without limitation, automatable tasks 139 with higher priority, such as those with approaching deadlines, may be processed and assigned before lower-priority tasks. This can ensure that urgent tasks receive immediate attention, maintaining the system's efficiency and reliability. As used herein, a “priority queue” is a data structure that organizes tasks based on their priority levels, with the highest-priority tasks positioned at the front of the queue. The priority que may allow the system to efficiently manage and process tasks according to their urgency. The task performance executor generator may access the priority queue to distribute and assign automatable tasks 139 to the appropriate task executing machine-learning models 142. The generator 142 may follow the order of the queue, ensuring that the highest-priority tasks are assigned first. The task execution module, including multiple task executing machine-learning models 142, may process the automatable tasks 139 assigned from the priority queue. Task execution module 158 includes a plurality of task executing machine-learning models 142 trained with execution training data 152, wherein the plurality of task execution machine-learning models 142 is configured to automate the execution of the one or more automatable tasks 139. Each of plurality of “task executing machine-learning models” is a model that is configured to execute a different executable task associated with a specific task category. “Execution training data” is a set of data used to train a task executing machine-learning model. Execution training data 152 includes historical execution data 156. For the purposes of this disclosure, “historical execution data” is data related to previously executed automatable tasks. As a non-limiting example, historical execution data 156 may include previously executed sub-tasks 112 for previously executed automatable tasks 139. In some embodiments, historical execution data 156 may be stored in task performance database 136. In some embodiments, task execution module 158 may retrieve historical execution data 156 from a task performance database 136. In some embodiments, user may manually input historical execution data 156.

With continued reference to FIG. 1, system 100 includes a task execution module 158 operating on at least a server 104. Task execution module 158 includes a plurality of task executing machine-learning models 142 trained with execution training data 152. Task execution module 158 is designed and configured to execute one or more automatable tasks 139, assigned from task performance executor generator 150, using task executing machine-learning model 142 determined for the one or more automatable tasks 139. In some embodiments, task execution module 158 may be further designed and configured to identify one or more sub-tasks 112 as a function of historical execution data 156. For the purposes of this disclosure, a “sub-task” is an element of a task to be completed to execute one or more automatable tasks. Sub-task 112 disclosed herein is further described above. In some embodiments, task execution module 158 may execute one or more automatable tasks 139, assigned from task performance executor generator 150, as a function of one or more sub-tasks 112. In some embodiments, executing one or more automatable tasks 139 may include generating a data prompt 160 as a function one or more sub-tasks 112. For the purposes of this disclosure, a “data prompt” is a prompt that requests a user for additional data. In some embodiments, data prompt 160 may be configured to request additional data 162 related to one or more sub-tasks 112 to a user. For the purposes of this disclosure, “additional data” is data that is related to sub-tasks that is not in a system 100 received by a user. In some embodiments, executing one or more automatable tasks 139 may include transmitting data prompt 160 to a user device 114. In some embodiments, task execution module 158 may be further designed and configured to execute one or more automatable tasks 139 as a function of additional data 162 received from a user. In a non-limiting illustrative example, when task execution module 158 identifies a scheduling conflict or lacks sufficient information to execute one or more automatable tasks 139, task execution module 158 may generate a data prompt 160. As a non-limiting example, data prompt 160 may include a message like, “Please confirm your availability for the proposed meeting time,” along with options to select preferred times, contextual information about the meeting, and a request for a response within a specified timeframe. The recipient (e.g., a user) may receive data prompt 160 and may provide the necessary information (e.g., additional data 162), such as confirming their availability or suggesting alternative times. This response may be then processed by task execution module 158 to finalize the meeting schedule accurately and efficiently.

Continuing to refer to FIG. 1, task generator module 144 may include task performance owner generator 164. In some embodiments, task performance executor generator 150 may incorporate with task performance owner generator 164. Task performance owner generator may generate a label indicating owner of at least a request for a task performance. Task performance owner may include an individual who is in charge of giving approval to at least a request for a task performance. Approval may indicate that at least a request for a task performance is complete. Task performance owner generator 164 may generate a label containing a name of an individual who is the task performance owner for at least a request for a task performance. In an embodiment, task performance owner generator 164 may generate label with information provided by language processing module 124 such as parser 128 and/or language database 130.

With continued reference to FIG. 1, system 100 may include a transmission source module 166 operating on the at least a server 104. Transmission source module 166 may include any suitable hardware or software module. Transmission source module 166 may be designed and configured to transmit the at least a task performance data element containing the task performance datum list label and the priority label to at least a user device 114. User device 114 may include any of the user devices 114 as described above. In some embodiments, transmission source module 166 may generate a notification datum 168 as a function of execution of one or more automatable tasks 139 and transmit the notification datum 168 to a user device 114. For the purposes of this disclosure, a “notification datum” is a data element for communicating information related to automatable tasks to a user. As a non-limiting example, notification datum 168 may include a reminder, notification, and the like. For example, and without limitation, notification datum 168 may be configured to notify a user a current status, progress, or completion of tasks 110, automatable task identification, execution status, any issues encountered, and actions taken. As a non-limiting example, notification datum 168 may include email, SMS, push notifications, or in-app alerts. In some embodiments, transmission source module 166 may transmit notification datum 168 depending on user preferences, the urgency of the notification, and the nature of the task. In a non-limiting illustrative example, upon the completion of scheduling a meeting by task execution module 158, transmission source module 166 may generate a notification datum 168 indicating that the meeting has been successfully scheduled and confirmed. The notification datum 168 may be then transmitted to the relevant employee's device (e.g., user device 114) via email and push notification. The employee may receive the update, confirms the meeting time, and acknowledge the notification, ensuring that all parties are informed and aligned. In some embodiments, task execution module 158 may be further configured to generate a notification datum 168 as a function of the execution of the one or more automatable tasks 139 and transmit the notification datum 168 to a user device 114.

With continued reference to FIG. 1, system 100 may include a feedback mechanism 170 operating on at least one server 104. Feedback mechanism 170 may be designed and configured to analyze an execution outcome datum 172 received from receiving module 108, wherein the execution outcome datum 172 may include a user interaction datum 174 and refine a plurality of task executing machine-learning models 142 as a function of the analysis of execution outcome datum 172. For the purposes of this disclosure, a “feedback mechanism” is a component designed to enhance the system's performance by continuously learning from execution outcomes. Feedback mechanism 170 may include any suitable hardware or software module. In some embodiments, feedback mechanism 170 may analyze data from completed tasks (e.g., execution outcome datum 172) and user interactions to refine the task executing machine-learning models. The feedback loop may ensure that system 100 adapts and improves over time, increasing the accuracy and efficiency of task automation. For the purposes of this disclosure, an “execution outcome datum” is a data element that is generated as a result of the execution of automatable tasks. As a non-limiting example, execution outcome datum 172 may include task results, performance metrics 176, user interaction datum 174, issues, completion status, and the like. In some embodiments, execution outcome datum 172 may be received from a user, retrieve from a database, and the like. In some embodiments, feedback mechanism 170 may determine execution outcome datum 172 using a machine-learning module. By examining execution outcome datum 172, feedback mechanism 170 may identify patterns, errors, and opportunities for improvement. In some embodiments, execution outcome datum 172 may include details whether the task was completed successfully, partially completed, or failed. In some embodiments, execution outcome datum 172 may include an end product of the task execution, such as generated reports, processed data, or completed actions. For the purposes of this disclosure, a “performance metric” is a quantitative measure that assess the efficiency and effectiveness of the task execution. Performance metric 176 may include execution time, resource utilization, accuracy rates, error counts, and throughput, providing a numerical basis for evaluating the quality of the task execution. For the purposes of this disclosure, a “user interaction datum” is a data element that captures records of any interactions between a system and users during a task execution. As a non-limiting example, user interaction datum 174 may include user inputs, responses to prompts, confirmations, and feedback. User interaction datum 174 can help in understanding the human factors involved in the task execution and the level of user engagement. Additionally, execution outcome datum 172 may include issues and anomalies that are documented to record any problems, errors, or unexpected events encountered during the task execution. This may include system failures, data inconsistencies, or process interruptions. In some embodiments, feedback mechanism 170 may analyze execution outcome datum 172 through the use of machine-learning processes to find patterns or a user may manually analyze execution outcome datum 172. In a non-limiting example, user interaction datum 174 may capture any responses or feedback from a user, such as their satisfaction rating or additional comments and this may be used to refine task executing machine-learning model 142. This refinement process may include updating task executing machine-learning model 142 or execution training data 152 with analysis of execution outcome datum 172, adjusting algorithms, and incorporating user feedback to enhance their predictive accuracy and execution efficiency.

Referring now to FIG. 2, an exemplary embodiment of task performance lists as displayed to a user such as through GUI 116 is illustrated. Task performance list may include a description as to the category of at least a request for a task-performance. In an embodiment, all requests for at least a request for a task performance 204 may be initially placed onto an uncategorized list. Uncategorized list may include a master list containing all tasks from all users that are unprocessed. Tasks that are unprocessed may include, for example tasks that have not yet been assigned to a task performance list. Task performance list may include an action list 208, project list 212, and a waiting for list 216. Action list 208 may include any of the action lists as described above in reference to FIG. 1. Action list may include any actions that a user needs to perform. Action includes any task that does not include sub-task. Task performance list may include a project list 212. Project list 212 may include any of the project lists as described above in reference to FIG. 1. Project list may include any projects that a user needs to perform. Project includes a task that includes at least a sub-task. Task performance list may include a waiting for list 216. Waiting for list 216 may include a list of tasks assigned by a user to other people. Waiting for list 216 may contain an action and/or a project. In an embodiment, each task performance list may be customized to a user whereby action list 208 includes actions only user needs to perform, project list 212 includes projects user is involved with, and waiting for list contains only tasks such as actions and/or projects that user has assigned to others. In an embodiment, tasks such as actions and/or projects may appear on several lists such as when a user has assigned a sub-task of a project to another person and user is also completing a sub-task of the same project. In such an instance, the project would appear on user's project list 212 and the project would also appear on user's waiting for list 216, and the project would appear on the other person's project list 212. In an embodiment, tasks such as actions and/or projects may be mobile and may switch between task performance lists. For example, an action may initially be included on action list 208, and later may have a sub-task added to it, thereby moving it to project list 212. In yet another non-limiting example, a project listed on project list 212 and containing only sub-tasks to be completed by user may also later appear on waiting for list 216 when user assigns a sub-task of the project to another person. In yet another non-limiting example, a project containing only one sub-task that appears on project list 212 may be moved to action list 208 if the sub-task is later completed and/or deleted.

With continued reference to FIG. 2, task performance lists may be further categorized into further lists. In an embodiment, at least a request for a task performance may be received from user device 114 such as by user input such as speech or text via GUI 116. In an embodiment, action list 208 may be categorized into lists based on priority of action list task performances. Action list 208 may include further lists that may include high priority list 220 that may include actions that are of high priority. High priority list 220 may include for example, actions that may have a close due date and/or that are of high value and meaning such as a friend's wedding reception. Normal priority list 224 may include actions that are of regular importance such as everyday tasks or weekly appointments. Action list 208 may also contain a not accepted list 228 that may contain actions that a user has not yet accepted. Action list 208 may also contain an on hold list 232 for actions that are not ready to be performed. Project list 212 may be categorized into lists based priority of project list task performances. Project list 212 may include high priority list 236 that may include projects that are of high priority. High priority list 236 may include for example, projects that may have multiple sub-tasks and/or projects that are complex and take a long time to complete. Normal priority list 240 may include projects that are of regular importance such as projects that may not have an upcoming due date or projects that are not very complex and may not take tremendous amounts of time for a user to complete. Project list 212 may contain not accepted list 244 that may contain projects that a user has not yet accepted. Project list 212 may contain on hold list 248 for projects that will not be performed right away. For example, a project that contains a start date at a later date in the future may be placed on project on hold list 248. Waiting for list 216 may include high priority list 252 which may contain tasks including actions and/or projects that have been assigned to other individuals are of high priority. High priority waiting for list 252 may include for example, complex projects that have multiple sub-tasks that have been assigned to other individuals. Waiting for list 216 may include normal priority list 256 which may include actions and/or projects that are of regular importance and that have been assigned to other individuals. Waiting for list 216 may contain not accepted list 260 which may include tasks that have been assigned to another individual and have not yet been accepted by that individual yet. Waiting for list 216 may include on hold list 264 which may include actions and/or projects that have been put on hold and are not actively pursued at the current moment. In an embodiment, calendar 268 may aid in placing task performances on different task performance lists. For example, at least a request for a task performance received from user device 114 that has a start date three weeks down the road and does not contain any sub-tasks may be placed on action on hold list 232.

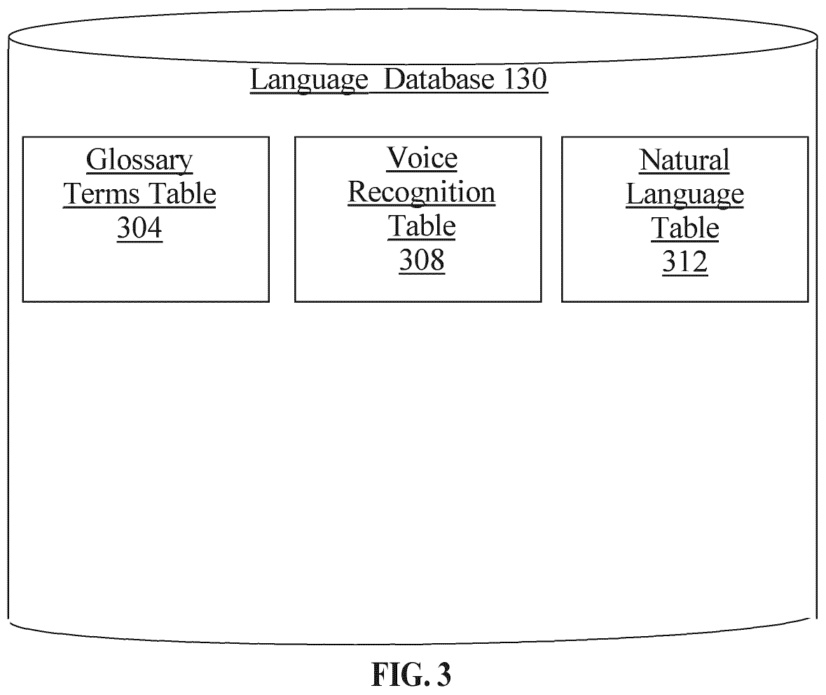

Referring now to FIG. 3, an exemplary embodiment of language database 130 is illustrated. Language database 130 may be implemented as any database and/or datastore suitable for use as a database. One or more database tables in task performance database may include glossary term table 304. Glossary term table 304 may contain terms and commands that may be specific to at least a request for a task performance. Glossary term table 304 may contain terms and commands that may be specific to a user and/or a group of users such as co-workers or family members and may not be known by others outside the group and as such may not parse correctly. For example, common adjectives may be dropped from names such as when Frank says drive my car users in the group would know which car belonged to Frank so that at least a request for a task performance that said, “drive Frank's car” would not need additional information such as “drive Frank's minivan.” Language database 130 may include voice recognition table 308 that may identify spoken commands and associates spoken commands with a user. Voice recognition table 308 may be utilized when a user interfaces with GUI 116 through a voice to text option. For example, voice recognition table 308 may be utilized when a user generates at least a request for a task performance such as “mow my lawn” to associate user who commands such a task performance with Sally based on voice recognition of Sally's voice. This may assist a user in having control over generating commands so that users do not impersonate one another. Language database 130 may include a natural language table 312 that may contain information pertaining to meaning of common language terms used in general conversations. In an embodiment, natural language table 312 may comprise multiple specialized, plurally accessible library-type databases. Natural language table 312 may be utilized to understand the contents of the at least a request for a task performance.

Referring now to FIG. 4, an exemplary embodiment of a task performance database 136 used by language processing module 124 is illustrated. Language processing module 124 may extract at least a datum from a database using the at least a request for a task performance datum and generate at least a task performance data element as a function of the at least a datum. Task performance database 136 may be implemented as any database and/or datastore suitable for use as a database. One or more database tables in task performance database 136 may include, without limitation, a past task performance table 404; past task performance table 404 may relate at least a request for a task performance to a previously performed past task performance. For example, at least a request for a task performance containing textual data such as “take the trash to the curb on Friday night” may be utilized to consult past task performance table 404 to determine if the same task had been previously performed and who performed the task. In such an instance, past task performance table 404 may include information as to categorization of similar past task performances such as whether taking the trash to the curb was an action and contained no sub-tasks and/or if it was a project and included other sub-tasks. Past task performance table 404 may include information regarding priority of past task performances. For example, a past task performance such as “organize church choir rehearsal” may have previously had a priority label such as normal whereas a past task performance such as “gather nonperishable food for hurricane victims” may have previously had a priority label of high. One or more database tables in task performance database 136 may include, without limitation, an input output table 408; input output table 408 may relate an input such at least a request for a task performance to an output such as a task performance list, a task performance owner and/or a priority label. For example, at least a request for a task performance such as “schedule dentist appoint” may be associated with an action list while at least a request for a task performance such as “organize church picnic” may be associated with a project list because it requires many sub-tasks in order to be completed. One or more database tables in task performance database 136 may include, without limitation, a user performance table 412; user performance table 412 may include information as to tasks such as projects and/or actions that user performs. For example, at least a request for a task performance that includes “mow the lawn” may not be assigned to a task owner such as user if mowing the lawn is not a task contained within user performance table 412. In an embodiment, user performance table 412 may be customized to a user and/or group of users. In yet another non-limiting example, at least a request for a task performance such as “prepare weekly reports” may be assigned to user if preparing weekly reports is included within user performance table 412 as a task user prefers to perform and/or has experience handling. One or more database tables in task performance database 136 may include, without limitation, general performance table 416; general performance table 416 may include information as to qualifications, certifications, skills, and/or standards that a user may need to have achieved in order to be assigned and/or complete at least a request for a task performance. For example, at least a request for a task performance such as “notarize deed for Fred” may not be assigned to a user who is not a notary. In yet another non-limiting example, at least a request for a task performance such as “drive Mark to surgery” may not be performed by a user who is not of legal age to drive a car. The above described tables and entries therein are provided solely for exemplary purposes. Persons skilled in the art, upon reviewing the entirety of this disclosure, will be aware of various additional examples for tables and/or relationships that may be included or recorded in task performance database consistently with this disclosure.

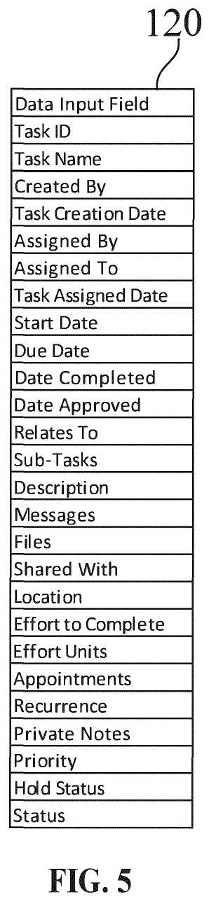

Referring now to FIG. 5, an exemplary embodiments of data input fields contained within user task performance input GUI 120 is illustrated. Data input fields may include information pertaining to at least a request for a task performance as described in more detail above in FIG. 1. In an embodiment, user may enter information into data input fields by typing entries into fields and/or by using a voice to text option such as when a user may be driving a car, or a user's hands may be tied up. In an embodiment, data input fields may contain a drop down menu that allows a user to select an option such as by highlighting a selection. Data input fields may include any of the data input fields as described above in FIG. 1, which may include for example, task ID, task name, created by, task creation date, assigned by, assigned to, task assigned date, start date, due date, date completed, date approved, relates to, sub-tasks, description, messages, files, shared with, location, effort to complete, effort units, appointments, recurrence, private notes, priority, hold status, and/or status.

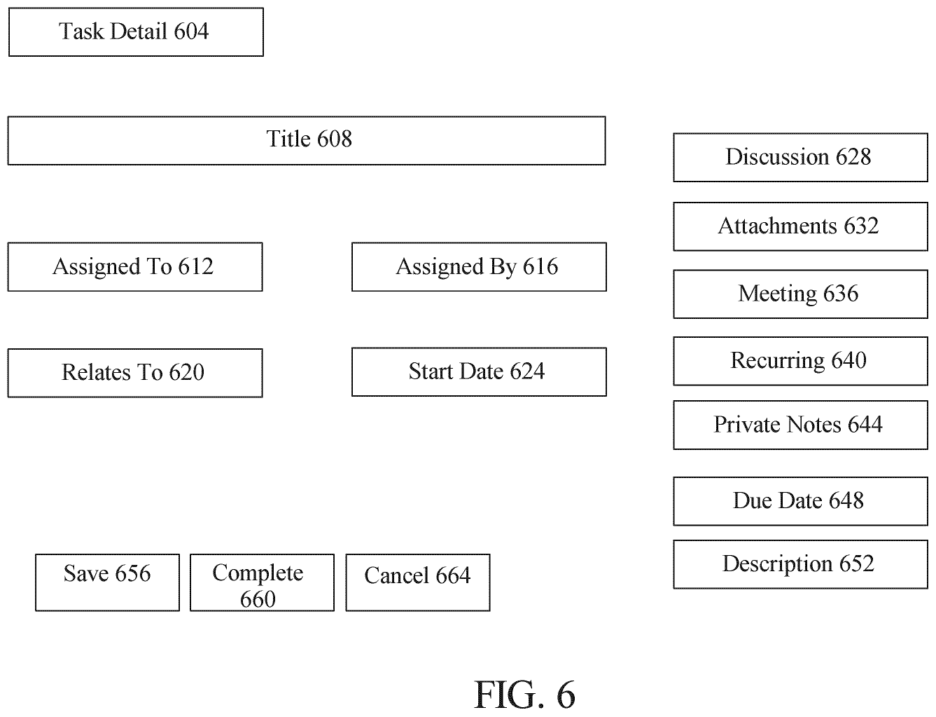

Referring now to FIG. 6, an exemplary embodiment of a screen a user may enter information relating to at least a request for a task performance at GUI 116 is illustrated. In an embodiment, a user may enter information relating to at least a request for a task performance by entering information into data fields by either typing and/or voice to text option. In an embodiment, to create at least a request for a task performance and/or to view information pertaining to at least a request for a task performance user may select within GUI 116 task detail 604. Task detail 604 may contain information about at least a request for a task performance such as title 608, name of individual task has been assigned to 612, name of individual task has been assigned by 616, a description of what the task relates to 620, and/or start date 624 for the task. In an embodiment, task detail 604 may contain data fields that a user can click on and expand to find out more detailed information relating to at least a request for a task performance. This may include a discussion field 628 which may contain a log of all discussions relating to a particular task. In an embodiment, task detail 604 may contain an attachments field that may contain any additional files such as documents and photographs that may relate to a particular task. In an embodiment, task detail 604 may contain a meeting field 636 which may contain a log of all past, present, and/or future appointments relating a particular task. In an embodiment, task detail 604 may contain a recurring 640 field which may allow a user to schedule a task performance on a recurring basis such as an appointment that is held weekly. In an embodiment, task detail 604 may contain a private notes 644 field that may allow a user to enter private notes relating to a task. In an embodiment, private notes 644 may only be viewed by a user who entered private notes unless user grants permission to share private notes 644 with another. In an embodiment, task detail 604 may contain a due date 648 field that may contain information as to when a task needs to be completed by. In an embodiment, task detail 604 may contain a description 652 field which may contain information summarizing a particular task. Task detail 604 may contain data field that a user can select to update information contained within task detail 604, which may include a save 656 button to save any updates or information that a user has entered, a complete 660 button when a task has been completed such as when a task owner grants approval to a task, and a cancel button 664 when a user needs to cancel a change or selection a user has accidentally made.

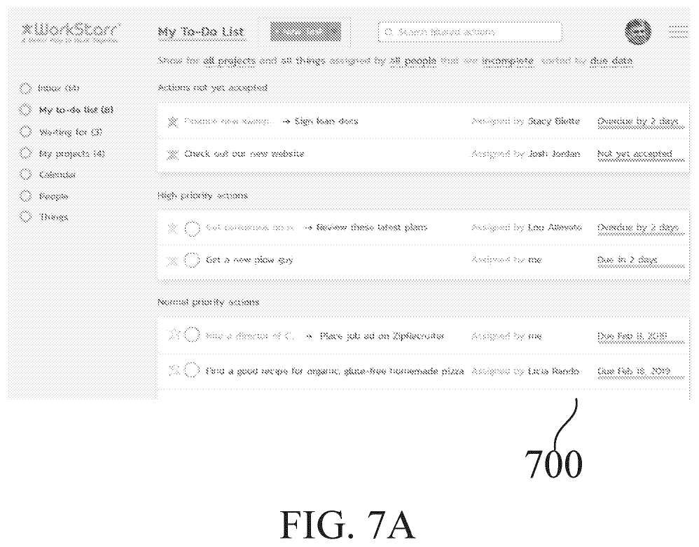

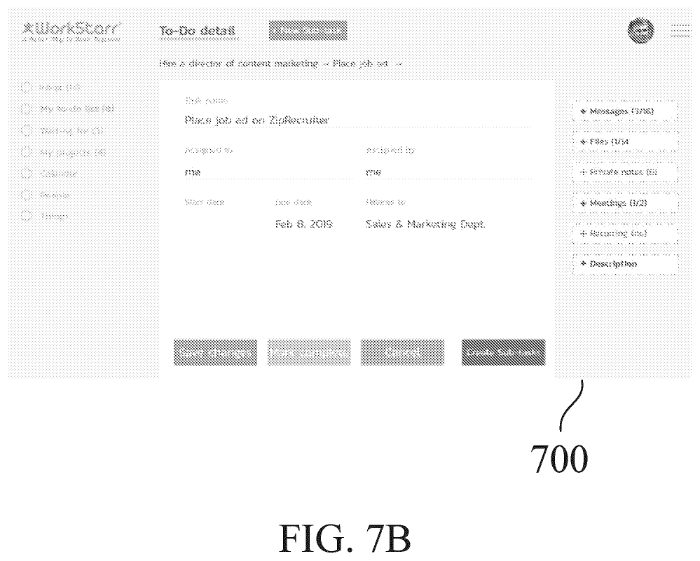

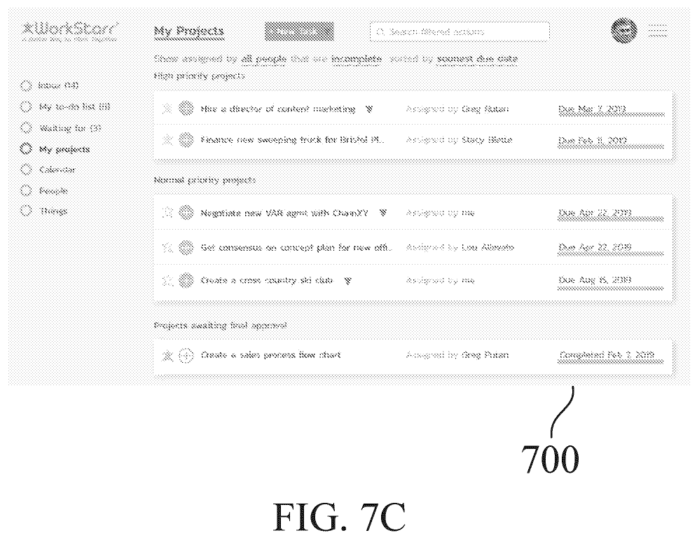

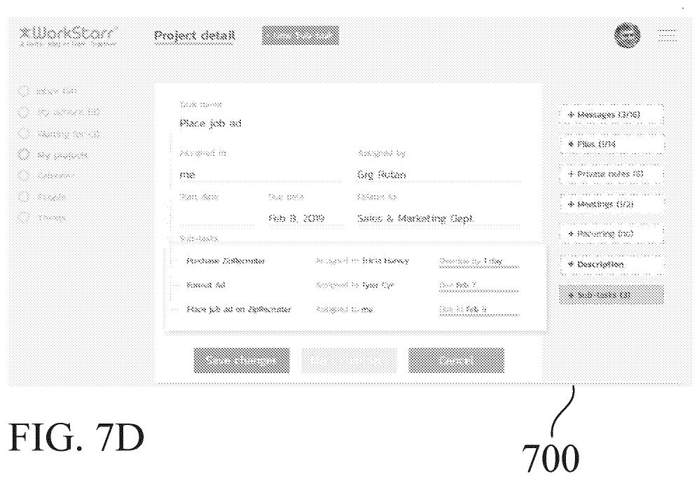

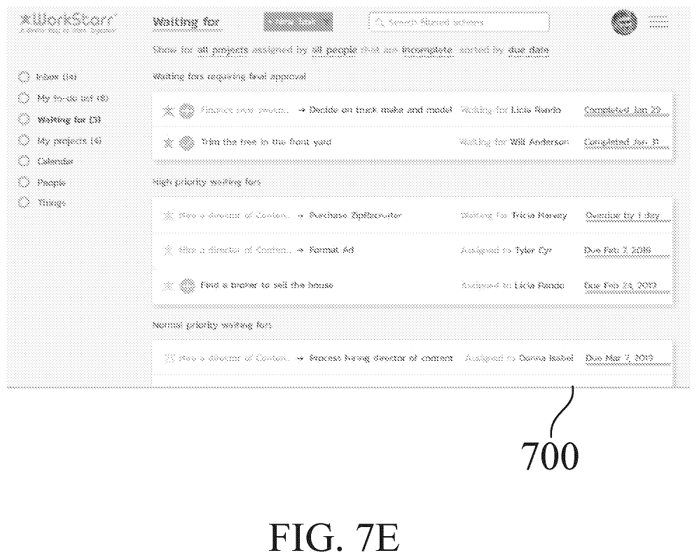

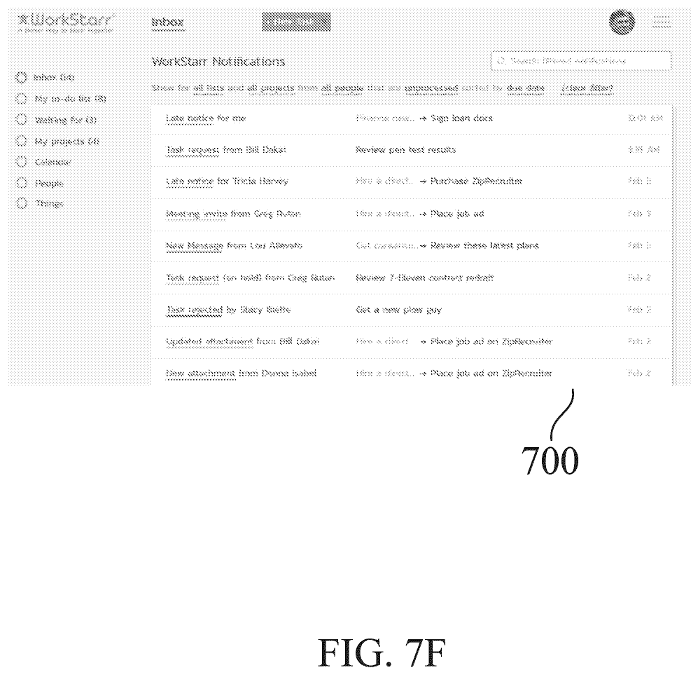

Referring now to FIG. 7A-F screenshots illustrating exemplary embodiments of GUI that a user may interact with and/or use to perform steps and processes in any of the methods described in this disclosure. GUI may function to translate machine-readable data into one or more fields, buttons, or the like into which users may enter commands into as an example, a textual field including any of the textual fields as described above in reference to FIGS. 1-5. For instance, and for illustrative purposes only, FIG. 7A shows a screen containing action list. In an embodiment, actions included on action list may be categorized by priority, with actions not yet accepted listed at the top of the action list, high priority actions listed in the middle of the action list, and normal priority actions listed at the bottom of the action list. In an embodiment, user may navigate to other task performance lists such as project list or waiting for list, as well as other categories such as calendar, people, and things by highlighting one of those options listed on the left side of the screen. FIG. 7B shows a screen containing an action detail where a user can fill in details pertaining to a specific action. For example, a user may fill in specific textual fields such as task name, assigned to, assigned by, start date, due date, and relates to. Action detail may allow a user to attach other materials and files relating to an action as listed on the right side of the screen, such as messages, files, private notes, recurring, and description. In an embodiment, textual fields and/or other materials may include any of the textual fields and/or other materials as described above in reference to FIGS. 1-6. FIG. 7C shows a screen containing project list. In an embodiment, a user may select a specific project contained within project list to expand information to reflect how many sub-tasks a particular project has completed at any given moment. In an embodiment, projects may be listed on project list by most recent projects to be added to project list. FIG. 7D shows a screen containing a project detail where a user can fill in specific textual fields pertaining a project such as task name, assigned to, assigned by, start date, due date, relates to, and sub-tasks. Project detail may allow a user to attach other materials and files relating to an action as listed on the right side of the screen, such as messages, files, private notes, recurring, and description. Project detail may allow a user to see different sub-tasks that comprise a project and see information such as who a particular sub-task has been assigned to as well as when a particular sub-task is due. FIG. 7E shows a screen containing a waiting for list. In an embodiment, waiting for list may be organized by priority, with high priority waiting for tasks listed at the top of the waiting for list, normal priority waiting for tasks listed in the middle of the waiting for list, and on hold waiting for tasks listed at the bottom of the waiting for list. In an embodiment, tasks listed on the waiting for list may contain information such as what person a user is waiting for completed a task listed on the waiting for list, as well as when the task is due. In an embodiment, user may navigate to other task performance lists such as action list or project list, as well as other categories such as calendar, people, and things by highlighting one of those options listed on the left side of the screen. FIG. 7F shows a screen containing an inbox list. Inbox list may contain a list compiling all lists a user may generate to include for example, all projects including actions from all people, and which may be sorted by due date. In an embodiment, user may navigate to other task performance lists such as action list, project list, waiting for list, as well as other categories such as calendar, people, and things by highlighting one of those options listed on the left side of the screen.

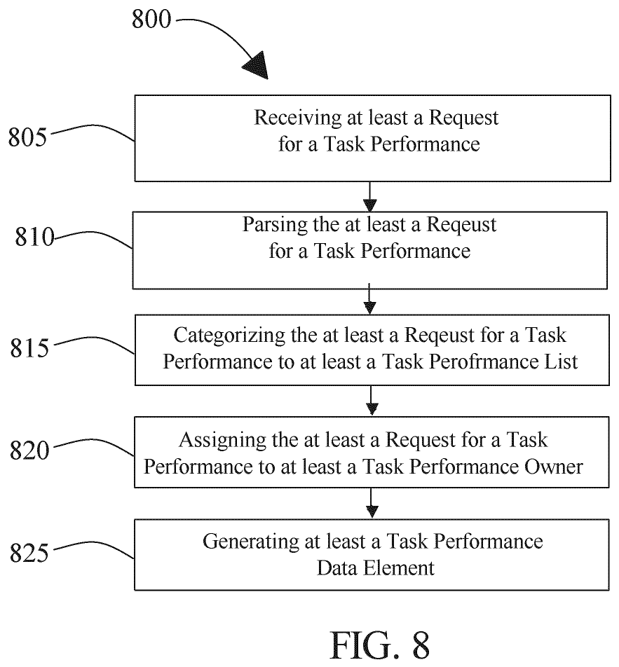

Referring now to FIG. 8, an exemplary embodiment of a method 800 of textual analysis of task performance datums is illustrated. At step 805 the at least a server receives at least a request for a task performance. Receiving at least a request for a task performance may be performed utilizing any type of network transmission and/or network connection as described herein. At least a request for a task performance may include receiving at least an action. An action may include a task containing no sub-tasks as described in more detail above in reference to FIGS. 1-7. An action may include any of the actions as described above in reference to FIGS. 1-7. At least a request for a task performance may include receiving at least a sub-task. At least a sub-task may comprise a project and may include any of the sub-tasks and/or projects as described above in FIGS. 1-7. At least a request for a task performance may be received from a user device 114. User device 114 may include any of the user devices 114 as described above in reference to FIG. 1. At least a request for a task performance may be received from a conversational response. Conversational response may include any of the conversational responses as described above in reference to FIG. 1, including for example emails or messages. Receiving at least a request for a task performance may include receiving at least a task performance file. Task performance file may include any of the task performance files as described above in reference to FIG. 1.

With continued reference to FIG. 8, at step 810 the at least a server parses the at least a request for a task performance to extract at least a task performance datum. Parsing may be performed by any of the methodologies as described above in reference to FIG. 1. Parsing may include normalizing one or more words or phrases contained within at least a request for a task performance, where normalization includes a process whereby one or more words or phrases are modified to match corrected or canonical forms; for instance, misspelled words may be modified to correctly spelled versions, words with alternative spellings may be converted to spellings adhering to a selected standard, such as American or British spellings, capitalizations and apostrophes may be corrected, and the like; this may be performed by reference to one or more “dictionary” data structures listing correct spellings and/or common misspellings and/or alternative spellings, or the like. Parsing may include performing algorithms such as those performed by language processing module 124 as described above in reference to FIG. 1. Parsing may include performing algorithms for name recognition. Name recognition may include a process whereby names of users, family members of users, co-workers of user, friends of users from sports, college, activities and the like are identified; this may include for example by searching for words, phrases, and/or names contained within task performance database 136. For example, language processing module 124 may identify a name contained within at least a request for a task performance and may consult task performance database 136 to verify if the name is contained within one of the database tables such as if the name is contained within past task performance table 404 because the named user previously performed the task.

With continued reference to FIG. 8, parsing may be performed by extracting and/or analyzing one or more words or phrases by performing dependency parsing processes; a dependency parsing process may be a process whereby language processing module 124 and/or parser 128 recognizes a sentence or clause and assigns a syntactic structure to the sentence or clause. Dependency parsing may include searching for or detecting syntactic elements such as subjects, objects, predicates or other verb-based syntactic structures, common phrases, nouns, adverbs, adjectives, and the like; such detected syntactic structures may be related to each other using a data structure and/or arrangement of data corresponding, as a non-limiting example, to a sentence diagram, parse tree, or similar representation of syntactic structure. In an embodiment, language processing module 124 may be configured, as part of dependency parsing, to generate a plurality of representations of syntactic structure, such as a plurality of parse trees, and select a correct representation from the plurality; this may be performed, without limitation, by use of syntactic disambiguation parsing algorithms such as, without limitation, Cocke-Kasami-Younger (CKY), Earley algorithm or Chart parsing algorithms. Disambiguation may alternatively or additionally be performed by comparison to representations of syntactic structures of similar phrases as detected using vector similarity, by reference to machine-learning algorithms and/or modules.

With continued reference to FIG. 8, parsing may include combining separately analyzed elements from at least a request for a task performance to extract at least a task performance datum; elements may include words, phrases, sentences, or the like, as described above. For instance, two elements may have closely related meanings as detected using vector similarity or the like; as a further non-limiting example, a first element may be determined to modify and/or have a syntactic dependency on a second element, using dependency analysis or similar processes as described above. Combination into at least a task performance datum may include, without limitation, concatenation. Alternatively or additionally, parsing may include detecting two or more elements in a single request for at least a task performance; for instance, parsing module may extract a conversational response and a user device response.

With continued reference to FIG. 8, parsing may include converting at least an element into at least a task performance datum for instance, and without limitation, once an element has been detected, parsing may convert it to a highly closely related task performance datum based on vector similarity, where the highly closely related element is labeled as a standard form or canonical element. Parsing may be performed by parser 128 as described in more detail above in FIG. 1. In an embodiment, converting to a standard form element may enable more efficient processing of element, as a reduced space of potential elements may be used to retrieve at least a task performance datum. In an embodiment, a datum may be retrieved from a database such as language database 130 and/or task performance database 136.

With continued reference to FIG. 8, parsing may extract at least a task performance datum. Task performance datum may include any of the task performance datums as described above that may include relevant information relating to the at least a request for a task performance. Relevant information may include for example information pertaining to a category of at least a request for a task performance, priority of the at least a request for a task performance and/or at least a task performance owner. For example, task performance datum may include information such as a high priority label given to at least a request for a task performance datum such as “terminate John's position on Monday.” In yet another non-limiting example, task performance datum may include information such as “Billy will be task owner.”

With continued reference to FIG. 8, at step 815 the at least a request for a task performance is categorized to at least a task performance list. Task performance list may include any of the task performance lists as described above in FIGS. 1-7. Categorizing the at least a request for a task performance may include assigning at least a request for a task performance to at least a task performance list. In an embodiment, at least a request for a task performance may be initially categorized into an uncategorized list, as described above in more detail in FIG. 2. Subsequently, at least a request for a task performance may be assigned to a task performance list including action list, project list, and/or waiting for list as described above in more detail in FIGS. 1-7. In an embodiment, at least a request for a task performance may be initially assigned to a task performance list such as action list because it does not contain any sub-tasks, but may be later moved to another list such as to project list when a sub-task is added.

With continued reference to FIG. 8, at step 820 the at least a request for a task performance is assigned to at least a task performance owner. Task performance owner as used herein includes the name of the individual who has been granted authority to grant approval to a task and mark it as complete. In an embodiment, task performance owner may or may not be the individual who may be completing a task. For example, John may generate an action that he will assign to Mary to complete, but John may still be named as the task owner because he will be in charge of granting approval to the task and ensuring that Mary has completed the task to his satisfaction. In an embodiment, task owner may be granted certain privileges such as delaying tasks and placing tasks on hold under the task owner decides to release the task.

With continued reference to FIG. 8, at step 820 the server generates at least a task performance data element as a function of the at least a task performance datum and containing at least a task performance list label and a priority label. Task performance list label may include a label indicating the task performance list that the at least a request for a task performance has been assigned to. For example, at least a request for a task performance that has been assigned to action list may contain a task performance list label that includes “action list.” Priority label may include a label indicating importance of at least a request for a task performance. For example, at least a request for a task performance that has been deemed of additional importance because it needs to be completed quickly or is of great value to a company, may include a priority label that includes “high priority.”

With continued reference to FIG. 8, the at least a task performance data element containing the task performance label and the priority label may be transmitted to at least a user device. User device may include any of the computing devices as described herein. Transmitting may include sending the task performance data element over a network connection and may be implemented, without limitation, as described herein.

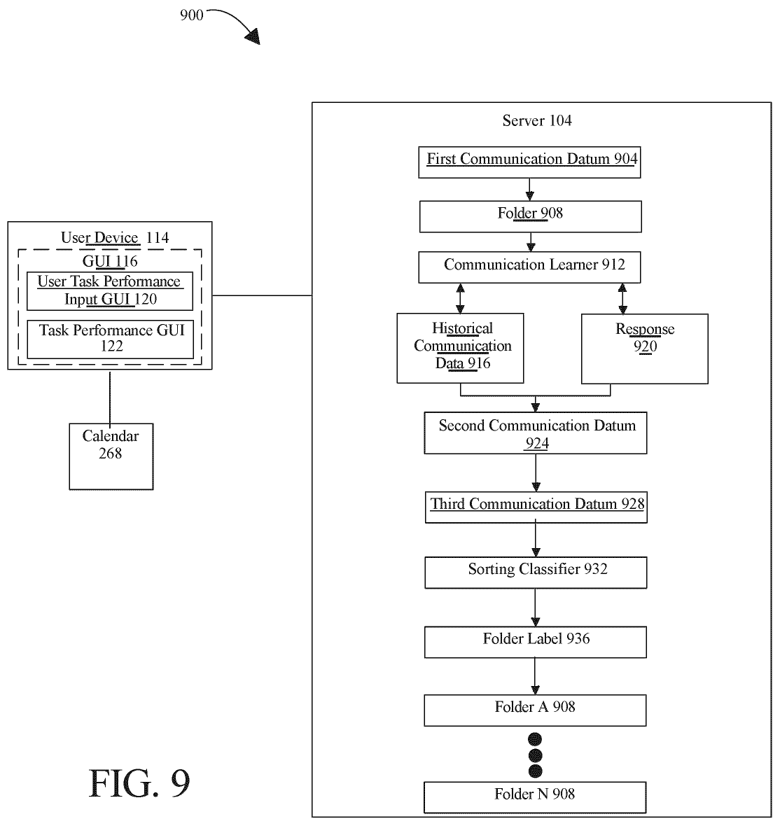

Referring now to FIG. 9, an exemplary embodiment of a system 900 for processing electronic communications is illustrated. System 900 includes a server 104. Server 104 includes any server 104 as described above in more detail in reference to FIG. 1. Server 104 is configured to receive a first communication datum 904. A “communication datum,” as used in this disclosure, is an electronic communication sent by a sender to a recipient. In an embodiment, the sender and the recipient may be same person. In an embodiment, the sender and the recipient may be different persons. A communication datum 904 may include but is not limited to electronic communications such as electronic mail, email, e-message, chat message, a voice mail, text message, direct message, instant message, and the like. For example, a communication datum 904 may include an email message generated by a sender such as a first co-worker and transmitted to a recipient such as a second co-worker. In yet another non-limiting example, a communication datum 904 may include a text message sent by a mother to her daughter. A first communication datum 904 may relate to a task performance, including any of the task performances as described herein, and/or a subtask. Server 104 locates a folder 908 relating to first communication datum 904 and a task performance. A “folder,” as used in this disclosure, is a group of communication datums. A folder 908 may be used to store and/or archive communication datums 904 that may be related to one another and/or a task performance. In an embodiment, a folder 908 may include an electronic mailbox and/or a portion of an electronic mailbox. In an embodiment, server 104 may generate a folder 908 for a task performance. For example, server 104 may generate a first folder 908 for a first task performance such as hiring a nanny, and a second folder 908 for a second task performance such as booking a vacation to Hawaii. Server 104 may locate a folder 908 relating to first communication datum 904 and a task performance. For instance and without limitation, a first communication datum 904 may relate to a list of groceries that a user is running low on and may run out of in the next upcoming days. In such an instance, server 104 may locate a folder 908 relating to a task of grocery shopping. Folder 908 may store information relating to previous items a user may have purchased at a grocery store, what budget a user has set for previous grocery shopping trips, and the like.

With continued reference to FIG. 9, server 104 is configured to examine a folder 908 and identify an outstanding task performance. An “outstanding task performance,” as used in this disclosure, is a task performance that has not yet been completed. An outstanding task performance may contain one or more entries located within action list 208, project list 212, and/or waiting for list 216. For example, an outstanding task performance may include a task for cleaning out the user's garage, which has not yet been completed. In yet another non-limiting example, an outstanding task performance may include a task that has been partially started, but is not yet completely finished, such as a user who has written a first draft of a science report, but still needs to complete a final review of the first draft, along with some editing. Server 104 generates a reminder relating to an outstanding task performance. A “reminder,” as used in this disclosure, is a prompt that alerts a user to an outstanding task performance. A prompt may include but is not limited to, an audiovisual display, an auditory alert, a mechanical alert such as a vibration and the like. For instance and without limitation, server 104 may examine a folder and identify an outstanding task performance, such as ordering coffee, which has been outstanding and overdue for at least 3 days. In such an instance, server 104 generates a reminder and displays a message within server 104, reminding a user to reorder coffee.

With continued reference to FIG. 9, server 104 is configured to generate a communication learner 912. Communication learner may be designed and configured to generate outputs using machine learning processes, including any of the machine-learning processes as described herein. Communication learner 912 uses historical communication data 916 as an input and outputs a response, using a first machine-learning process. “Historical communication data,” as used in this disclosure, is any previous conversations, remarks, and/or replies generated by a user. Historical communication data 916 may be obtained from a previous historical communication datum, including but not limiting to a communication datum contained within electronic mail, email, e-message, chat message, a voice mail, text message, direct message, instant message, and the like. For instance and without limitation, a historical communication datum 916 may include a previous email response that a user drafted and sent to a contact, such as the user's co-worker. Communication learner 912 outputs a response 920, using a first machine-learning process. A “response,” as used in this disclosure, is an answer output by communication learner 912. A response 920 may include a communication. A communication may include an answer generated in response to a first communication datum 904. An “answer” as used in this disclosure, is any reply remark to a first communication datum 904. An answer may include a reply such as a textual response, an email response, a text message reply, and the like. For instance and without limitation, a first communication datum 904 may include an email containing a remark seeking to confirm a dinner reservation for later that evening. Communication learner 912 outputs a response 920 as a function of generating communication learner 912. Communication learner 912 may generate a response 920 that generates a communication such as a subsequent email containing an answer, confirming the dinner reservation for later that evening, using prose and style of previous user responses. A response may include a command. A “command,” as used in this disclosure, is a subsequent step and/or activity, instructing server 104 what to do next. A subsequent step may include locating an additional folder, reviewing a subsequent task performance, and the like.

With continued reference to FIG. 9, server 104 may be configured to identify a second communication datum 924 as a function of response 920. A “second communication datum,” as used in this disclosure, includes anything suitable for use as first communication datum 904 as described above in more detail. Server 104 may identify a second communication datum 924 using information contained within response 920. For example, response 920 may identify a particular folder 908 where second communication datum 924 may be located. In yet another non-limiting example, response 920 may contain second communication datum 924. Server 104 may select a second communication datum 924 using a task performance, including any subtasks and/or actions. For instance and without limitation, first communication datum 904 may relate to a task performance such as an upcoming graduation party. Server 104 may identify a second communication datum 924 that relates to the upcoming graduation party, such as a sub-task that includes ordering balloons. Such information may then be organized and stored together in folder 908 relating to the task performance of graduation party. Server 104 generate a reply relating to second communication datum 924. A “reply,” as used in this disclosure, is an answer and/or response generated relating to second communication datum 924. A reply may include generation of a task performance. Server 104 retrieves a device identifier contained within folder 908. A device identifier may identify a user and/or third-party that a reply is intended for. Server 104 transmits a reply to a device as a function of a device identifier. A device may include any device suitable for use as user device 114. Transmission may occur using any network methodology as described herein. For instance and without limitation, a reply may be generated for a user's mother based on a second communication datum 924 such as an email, asking the user to pick up the mother's dry cleaning. Server 104 generates a reply relating to second communication datum 924, such as a message that informs the user's mother that the user will pick up the dry cleaning. Server 104 retrieves a device identifier contained within folder 908 and transmits a reply to the device. Server 104 may generate a reply by parsing historical communication data 916 to identify a reply element. Parsing may be performed using any of the methods as described above in more detail in reference to FIGS. 1-8. A “reply element,” as used in this disclosure, is a signature style of a user when replying to communication datums. A reply element may include a particular prose of language, use of language, formatting style, word choice, diction, nature of response, and the like. Server 104 generates a reply as a function of a reply element. For instance and without limitation, server 104 may parse historical communication data 916, and identify a reply element such as a user's frequent use of poetic prose, when drafting emails. In such an instance, server 104 generates a reply using poetic prose.

With continued reference to FIG. 9, server 104 may be configured to update folder 908 to include second communication datum 924. Updating may include storing second communication datum 924 within folder 908. Updating may include identifying a task performance and/or a subtask relating to second communication datum 924. For example, server 104 may identify a task performance and/or a subtask such as buying a birthday present for John which relates to second communication datum 924 which contains an email asking John what he would like for his birthday. In such an instance, server 104 may store second communication datum 924 within folder 908 as a function of a task performance and/or a subtask. In an embodiment, communication datums may be stored within folder 908 and organized by task performance.

With continued reference to FIG. 9, server 104 may receive a third communication datum 928, whereby third communication datum 928 may include any item suitable for use as first and/or second communication datum as described above in more detail. Server 104 generates a sorting classifier 932. A “classifier,” as used in this disclosure, is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric or the like. Sorting classifier 932 may be generated using a classification algorithm, defined as a process whereby server 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. Sorting classifier 932 uses a communication datum as an input, and outputs a folder label 936. A “folder label 936,” as used in this disclosure, is a category describing the contents of communication datums contained within folder 908. For instance and without limitation, a folder label 936 may categorize the contents of a folder 908 containing communication datums relating to medical appointments and medical procedures as “medical.” In yet another non-limiting example, a folder label 936 may categorize the contents of a folder 908 containing communication datums relating to a series of various volunteer project as “volunteer work.” A folder label 936 may indicate and/or describe a task performance and/or subtask that a folder 908 may relate to. For instance and without limitation, a folder label 936 may specify a folder 908 as relating to dry cleaning, for all communication datums stored within the folder 908 that relate to a user's dry cleaning including previous dry cleaning receipts, clothes that a user gets dry cleaned, how much money a user typically spends on dry cleaning and the like. Server 104 generates a folder label 936 for third communication datum 928 as a function of sorting classifier 932. Server 104 locates a folder as a function of a folder label 936, and stores third communication datum 928 within the folder. In an embodiment, server 104 may match a folder label 936 to a folder. For example, a folder label 936 specifying “fitness” may be used to locate a folder that contains communication datums relating to fitness. In an embodiment, parser 128 may be utilized to locate a folder containing communication datums relating to fitness. Server 104 may generate a folder label 936 as a function of a task performance. For example, folder 908 may contain a plurality of communication datums relating to a task performance such as gardening a user's lawn. In such an instance, the task performance of gardening a user's lawn may be used to generate a folder label 936 that specifies “gardening.”

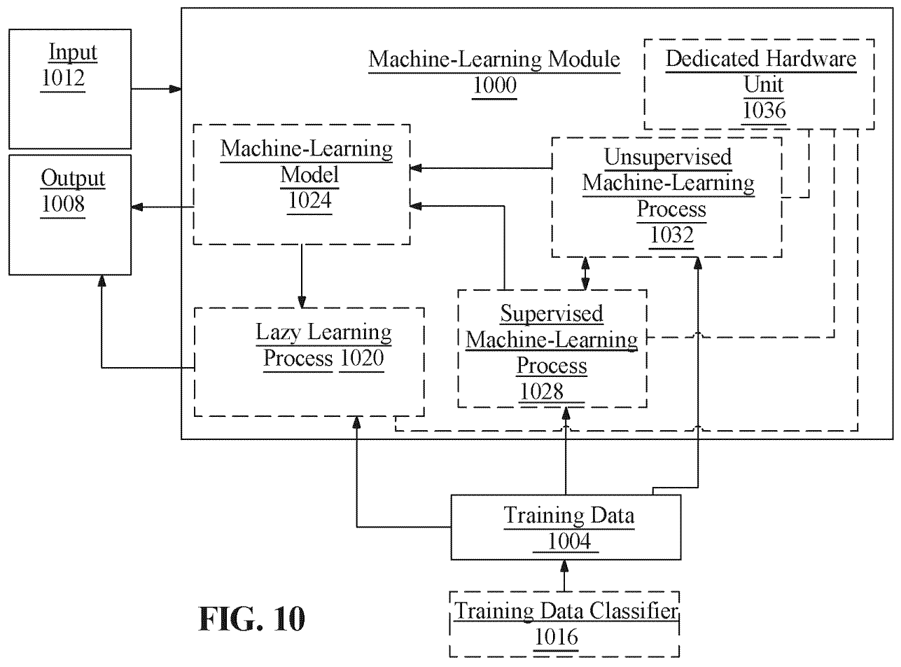

Referring now to FIG. 10, an exemplary embodiment of a machine-learning module 1000 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1004 to generate an algorithm instantiated in hardware or software logic, data structures, and/or functions that will be performed by a computing device/module to produce outputs 1008 given data provided as inputs 1012; this is in contrast to a non-machine learning software program where the commands to be executed are determined in advance by a user and written in a programming language.

Still referring to FIG. 10, “training data,” as used herein, is data containing correlations that a machine-learning process may use to model relationships between two or more categories of data elements. For instance, and without limitation, training data 1004 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1004 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1004 according to various correlations; correlations may indicate causative and/or predictive links between categories of data elements, which may be modeled as relationships such as mathematical relationships by machine-learning processes as described in further detail below. Training data 1004 may be formatted and/or organized by categories of data elements, for instance by associating data elements with one or more descriptors corresponding to categories of data elements. As a non-limiting example, training data 1004 may include data entered in standardized forms by persons or processes, such that entry of a given data element in a given field in a form may be mapped to one or more descriptors of categories. Elements in training data 1004 may be linked to descriptors of categories by tags, tokens, or other data elements; for instance, and without limitation, training data 1004 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 10, training data 1004 may include one or more elements that are not categorized; that is, training data 1004 may not be formatted or contain descriptors for some elements of data. Machine-learning algorithms and/or other processes may sort training data 1004 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1004 to be made applicable for two or more distinct machine-learning algorithms as described in further detail below. Training data 1004 used by machine-learning module 1000 may correlate any input data as described in this disclosure to any output data as described in this disclosure. As a non-limiting illustrative example, input data may include a plurality of tasks 110, task categories 118, automatable task 139, task data 140, sub-tasks 112, execution training data 152, additional data 162, conversational response, request for a task performance, task performance datum, execution outcome datum 172, user interaction datum 174, performance metric 176, and the like. As a non-limiting illustrative example, output data may include a plurality of tasks 110, task categories 118, automatable task 139, task data 140, sub-tasks 112, execution training data 152, additional data 162, conversational response, request for a task performance, task performance datum, execution outcome datum 172, user interaction datum 174, performance metric 176, data prompt 160, and the like.

Further referring to FIG. 10, training data may be filtered, sorted, and/or selected using one or more supervised and/or unsupervised machine-learning processes and/or models as described in further detail below; such models may include without limitation a training data classifier 1016. Training data classifier 1016 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1000 may generate a classifier using a classification algorithm, defined as a processes whereby a computing device and/or any module and/or component operating thereon derives a classifier from training data 1004. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1016 may classify elements of training data to user cohorts. For example, without limitation, training data classifier 1016 may classify elements of training data to user cohorts related to user's age, gender, occupation, location, and the like.

Still referring to FIG. 10, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A) P (A)=P (B), where P (A/B) is the probability of hypothesis A given data B also known as posterior probability; P (B/A) is the probability of data B given that the hypothesis A was true; P (A) is the probability of hypothesis A being true regardless of data also known as prior probability of A; and P (B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 10, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 10, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 10, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 10, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 10, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 10, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 10, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 10, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 10, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 10, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}} .$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{median}}{IQR} .$$

Persons skilled in the art, upon reviewing the entirety of this disclosure, will be aware of various alternative or additional approaches that may be used for feature scaling.

Further referring to FIG. 10, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 10, machine-learning module 1000 may be configured to perform a lazy-learning process 1020 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1004. Heuristic may include selecting some number of highest-ranking associations and/or training data 1004 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 10, machine-learning processes as described in this disclosure may be used to generate machine-learning models 1024. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1024 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1024 may be generated by creating an artificial neural network, such as a convolutional neural network comprising an input layer of nodes, one or more intermediate layers, and an output layer of nodes. Connections between nodes may be created via the process of “training” the network, in which elements from a training data 1004 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 10, machine-learning algorithms may include at least a supervised machine-learning process 1028. At least a supervised machine-learning process 1028, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include plurality of tasks 110, task categories 118, automatable task 139, task data 140, sub-tasks 112, execution training data 152, additional data 162, conversational response, request for a task performance, task performance datum, execution outcome datum 172, user interaction datum 174, performance metric 176, and the like as described above as inputs, a plurality of tasks 110, task categories 118, automatable task 139, task data 140, sub-tasks 112, execution training data 152, additional data 162, conversational response, request for a task performance, task performance datum, execution outcome datum 172, user interaction datum 174, performance metric 176, data prompt 160, and the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1004. Persons skilled in the art, upon reviewing the entirety of this disclosure, will be aware of various possible variations of at least a supervised machine-learning process 1028 that may be used to determine relation between inputs and outputs. Supervised machine-learning processes may include classification algorithms as defined above.

With further reference to FIG. 10, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 10, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 10, machine learning processes may include at least an unsupervised machine-learning processes 1032. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1032 may not require a response variable; unsupervised processes 1032 may be used to find interesting patterns and/or inferences between variables, to determine a degree of correlation between two or more variables, or the like.

Still referring to FIG. 10, machine-learning module 1000 may be designed and configured to create a machine-learning model 1024 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 10, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 10, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 10, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 10, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 10, one or more processes or algorithms described above may be performed by at least a dedicated hardware unit 1036. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1036 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1036 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1036 to perform one or more operations described herein, such as evaluation of model and/or algorithm outputs, one-time or iterative updates to parameters, coefficients, weights, and/or biases, and/or any other operations such as vector and/or matrix operations as described in this disclosure.

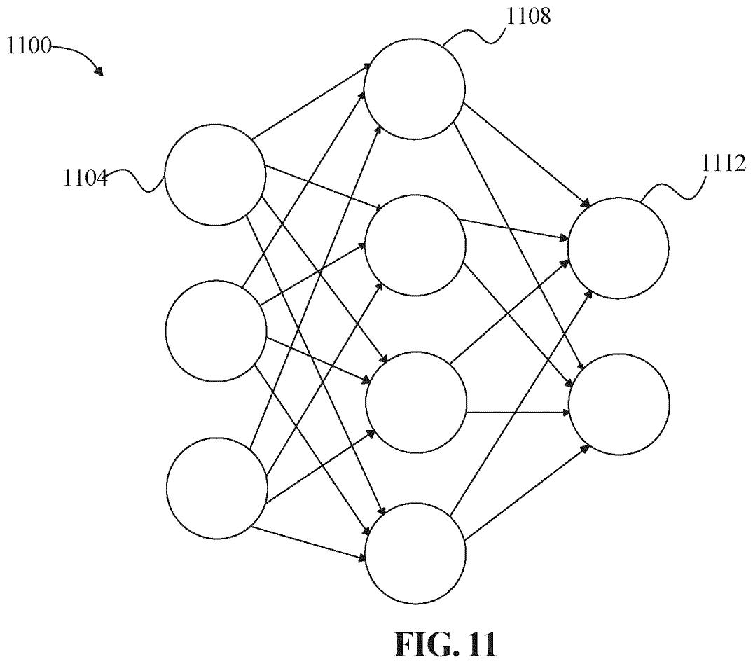

Referring now to FIG. 11, an exemplary embodiment of neural network 1100 is illustrated. A neural network 1100 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1104, one or more intermediate layers 1108, and an output layer of nodes 1112. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

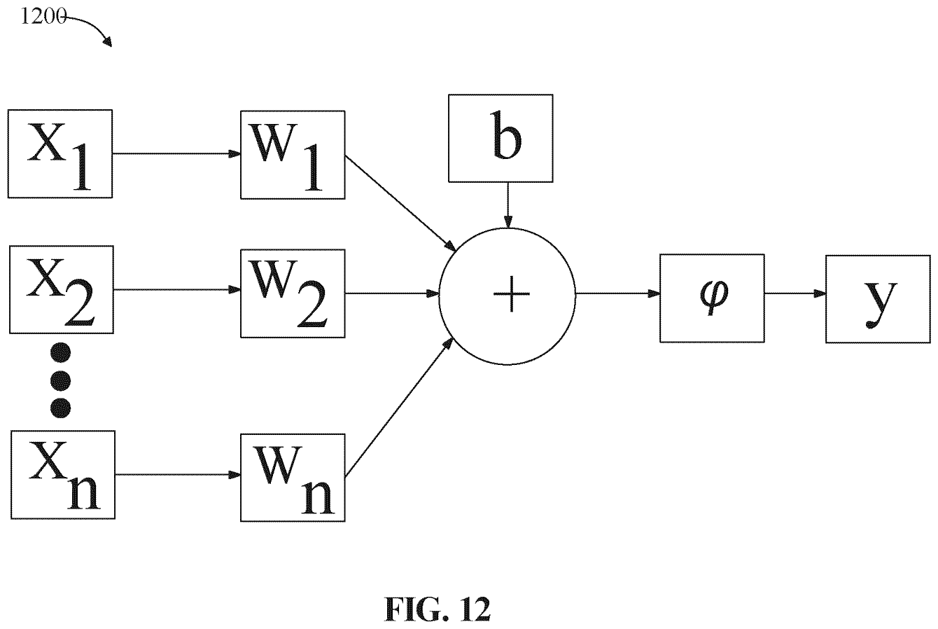

Referring now to FIG. 12 an exemplary embodiment of a node 1200 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max (0, x), a “leaky” and/or “parametric” rectified linear unit function such as f(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid (x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function q, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

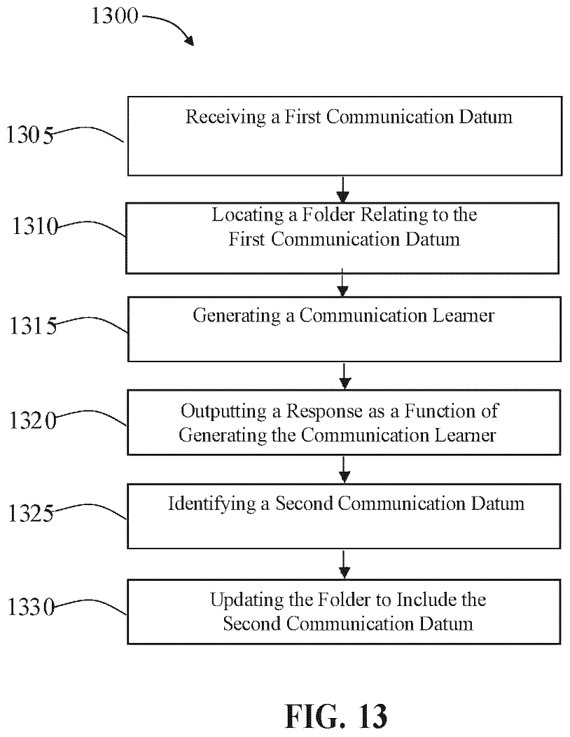

Referring now to FIG. 13, an exemplary embodiment 1300 of a method of processing electronic communications is illustrated. At step 1305, server 104 receives a first communication datum 904. First communication datum 904 includes any of the communication datums 904 as described above in more detail in reference to FIG. 9. A communication datum 904 includes an electronic communication sent by a sender to a recipient, including but not limited to electronic mail, email, e-message, chat message, a voice mail, text message, direct message, instant message, and the like. Server 104 receives a first communication datum 904 utilizing any network methodology as described herein.

With continued reference to FIG. 13, at step 1310, server 104 locates a folder 908 relating to first communication datum 904 and a task performance. Folder 908 includes any of the folders as described above in more detail in reference to FIG. 9. Folder 908 may include an electronic mailbox and/or a portion of an electronic mailbox, such as a sub-folder used to organize, collect, and store communication datums relating to a particular topic, event, matter, subject and the like. Folder 908 may relate to a task performance, a plurality of task-performances, and/or a subtask as described herein. For instance and without limitation, folder 908 may contain all information including communication datums, historical data, current email exchanges and the like relating to all task performances that relate to tasks a user completes in a user's personal life. In yet another non-limiting example, folder 908 may contain all communication datums relating to a task performance such as lawnmowing. Server 104 may locate a folder 908 relating to first communication datum 904 such as by using parser 128. For example, a first communication datum 904 that relates to a science fair project may be used to locate a folder 908 containing other communication datums relating to the science fair project. In yet another non-limiting example, first communication datum 904 that relates to a traffic study for a work related project may be used to locate a folder 908 containing other communication datums relating to the traffic study. Server 104 may examine folder 908 and identify an outstanding task performance. Examining a folder 908 may include using parser 128 to determine due date of task performances stored within folder 908, to evaluate and determine which task performances may be overdue. In an embodiment, an overdue task performance may be labeled as such and stored within folder 908. For instance and without limitation, a task performance such as finding a new recipe for organic gluten free pizza may be stored within a folder 908 relating to cooking, and whereby the task for finding the new recipe may be overdue by three days, and identified as such within folder 908. An outstanding task performance includes any of the outstanding task performances as described above in more detail. For example, an outstanding task performance may contain an overdue project and/or action needed to complete a task performance. Server 104 may generate a reminder relating to an outstanding task performance. A reminder includes any of the reminders as described above in more detail. For example, a reminder may include an alert such as a textual output, displaying to the user a message prompting the user to remember that a task performance such as gardening flowerbeds is overdue and has not yet been completed.

With continued reference to FIG. 13, at step 1315, server 104 generates a communication learner 912. Communication learner 912 includes any of the communication learners 912 as described above in more detail in reference to FIG. 9. Communication learner 912 uses historical communication data 916 as an input, and outputs a response 920, using a first machine learning process. Historical communication data 916 includes any of the historical communication data 916 as described above in more detail. For example, historical communication data 916 may contain previous conversations, remarks, and/or replies generated by a user, such as previous emails, prior conversations, prior decisions, prior answers, and the like. Communication learner 912 generates a first machine learning process, including any of the machine learning processes as described above in more detail in reference to FIGS. 1-12.

With continued reference to FIG. 13, at step 1320, communication learner 912 outputs a response 920, which contains an answer. Response 920 may include a communication, including any of the communications as described above in more detail in reference to FIG. 9. Response 920 may include a command, including any of the commands as described above in more detail in reference to FIG. 9. Server 104 receives an input containing a plurality of historical communication data inputs. This may be performed utilizing any of the methodologies as described herein. Server 104 creates a communication training set. Communication training set contains a plurality of data entries containing historical communication data correlated to respective responses. Server 104 may create communication training set using any of the methodologies as described above in more detail in reference to FIGS. 9-10. Server 104 trains communication learner 912, using communication training set.

With continued reference to FIG. 13, at step 1325 server 104 identifies a second communication datum 924 as a function of response 920. Second communication datum 924 includes any communication datum as described above in more detail. Server 104 may identify second communication datum 924, such by examining folder 908. For instance and without limitation, server 104 may generate a query and search folder 908 to identify second communication datum 924 that relates to first communication datum 904. For instance and without limitation, a first communication datum 904 relating to an upcoming birthday party may be used to identify a second communication datum 924 that relates to a cake flavor for the upcoming birthday party. Server 104 may generate a reply relating to second communication datum 924. A reply includes any of the replies as described above in more detail above. A reply may include an answer and/or response generated relating to second communication datum 924. In an embodiment, a reply may include generation of a task performance, and may include generation of an action and/or a project. Server 104 retrieves a device identifier contained within folder 908 and transmits a reply to a user device as a function of the device identifier. For instance and without limitation, second communication datum 924 may relate to the selection of various menu items from a restaurant that a user would like to order for an upcoming holiday party. Server 104 may generate a reply identifying the menu items the user seeks to order, and locate a device identifier contained within folder 908, for the device operated by the restaurant. In such an instance, server 104 transmits the reply to a device as a function of the device identifier. Server 104 may generate a reply by parsing historical communication data 916 to identify a reply element. A reply element includes any of the reply elements as described above in more detail in reference to FIG. 1. In an embodiment, a reply element may contain a particular communication style and/or prose that a user employs when generating messages such as responses to emails or text messages. In yet another non-limiting example, a reply element may contain a standard response and/or reply that a user employs for certain messages and/or answers. For instance and without limitation, a reply element may identify that a user on average orders a medium iced coffee from the same coffee shop every morning. In such an instance, server 104 may generate a reply instructing the user's secretary to order the user a medium iced coffee.

With continued reference to FIG. 13, at step 1330, server 104 updates folder 908 to include second communication datum 924. Updating my include storing second communication datum 924 within folder 908. In an embodiment, server 104 may store second communication datum 924 together with first communication datum 904. In such an instance, first communication datum 904 and second communication datum 924 may relate to a task performance, an action, a project, and the like, and may contain a label and/or indicator identifying the task performance, action, and/or project that both relate to. For instance and without limitation, first communication datum 904 may relate to a first task performance such as grocery shopping, and second communication datum 924 may relate to a second task performance such as locating recipes that a user wishes to cook over the course of an upcoming week. In such an instance, first communication datum 904 and second communication datum 924 may both relate to nourishment and nutrition. Updating folder 908 may include identifying a task performance relating to second communication datum 924 and storing second communication datum 924 within folder 908 as a function of the task performance. For instance and without limitation, server 104 may identify a task performance such as picking up dry cleaning, which relates to second communication datum 924 which includes an email reminding a user that the user's dry cleaning is ready for pickup. In such an instance, server 104 may store the second communication datum 924 and task performance together within folder 908.

With continued reference to FIG. 13, server 104 may receive a third communication datum 928. A third communication datum 928 includes any communication datum as described herein. Server 104 generates a sorting classifier 932, which uses a communication datum as an input and outputs a folder label 936. Sorting classifier 932 may be implemented as any classifier as described herein. Sorting classifier 932 may utilize third communication datum 928 as an input, and outputs a folder label 936 for third communication datum 928. In an embodiment, a folder label 936 may identify the contents of a folder, and/or the theme and/or focus of a folder and/or third communication datum 928. For instance and without limitation, a folder label 936 may identify a third communication datum 928 as relating to health and wellness of a user, when a third communication datum 928 identifies an outstanding task to reschedule a personal training session. In an embodiment, a folder label 936 may be generated as a function of a task performance, such as when third communication datum 928 relates to a task performance. A folder label 936 includes any of the folder label 936s as described above in more detail. Server 104 locates a folder as a function of a folder label 936, and stores third communication datum 928 within the folder. This may be performed utilizing any methodologies as described herein.

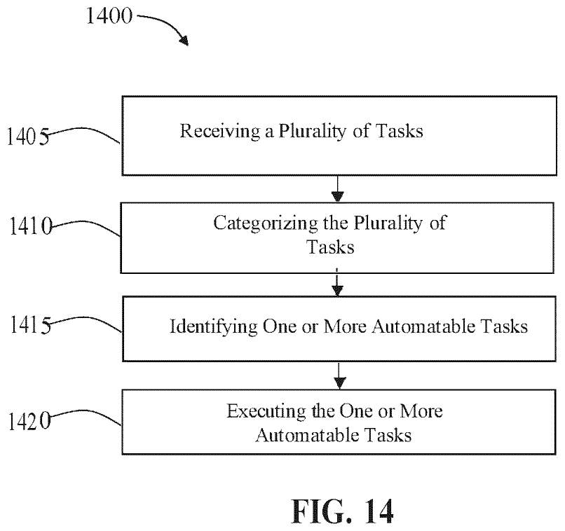

Referring now to FIG. 14, a flow diagram of an exemplary method 1400 for processing electronic communications is illustrated. Method 1400 contains a step 1405 of receiving, from at least a server, a plurality of tasks. This may be implemented as reference to FIGS. 1-13.

With continued reference to FIG. 14, method 1400 contains a step 1410 of categorizing, using a data organizer operating on at least one server, a plurality of tasks to one or more task categories. In some embodiments, method 1400 may further include distributing, using the data organizer, each of the one or more automatable tasks to one task executing machine-learning model of the plurality of task executing machine-learning models as a function of the one or more task categories. In some embodiments, method 1400 may further include loading, using the data organizer, the one or more automatable tasks in a priority queue and distributing, using the data organizer, each of the one or more automatable tasks to one task executing machine-learning model of the plurality of task executing machine-learning models as a function of the priority queue. In some embodiments, method 1400 may further include receiving, using the data organizer, a conversational response from a user device associated with at least a user and identifying, using a language processing module and the data organizer, at least a request for a task performance as a function of the conversational response, wherein the at least a request for a task performance is associated with the plurality of tasks. These may be implemented as reference to FIGS. 1-13.

With continued reference to FIG. 14, method 1400 contains a step 1415 of identifying, using a task identification module operating on at least one server, one or more automatable tasks for each one of the one or more task categories using a task identifying machine-learning model trained with task identification training data, wherein the task identification training data comprises exemplary tasks correlated to exemplary automatable tasks. This may be implemented as reference to FIGS. 1-13.

With continued reference to FIG. 14, method 1400 contains a step 1420 of executing, using a task execution module operating on at least one server, one or more automatable tasks as a function of one or more task categories, wherein the plurality of task execution machine-learning models is configured to automate the execution of the one or more automatable tasks. In some embodiments, each one of the one or more automatable tasks may include at least a portion of each task of the plurality of tasks that can be automatically executed. In some embodiments, executing the one or more automatable tasks may include generating a data prompt as a function the plurality of tasks, wherein the data prompt is configured to request additional data related to the plurality of tasks to a user, transmitting the data prompt to a user device and executing the one or more automatable tasks as a function of the additional data received from the user. In some embodiments, each of the plurality of task executing machine-learning models is configured to execute a different executable task associated with a specific task category and the execution training data may include historical execution data. In some embodiments, method 1400 may further include receiving, using a feedback mechanism of the task execution module, an execution outcome datum and refining, using the feedback mechanism, the plurality of task executing machine-learning models as a function of evaluations of the execution outcome datum. In some embodiments, the execution outcome datum may further include a performance metric. In some embodiments, method 1400 may further include generating, using the task execution module, a notification datum as a function of the execution of the one or more automatable tasks and transmitting, using the task execution module, the notification datum to a user device. These may be implemented as reference to FIGS. 1-13.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

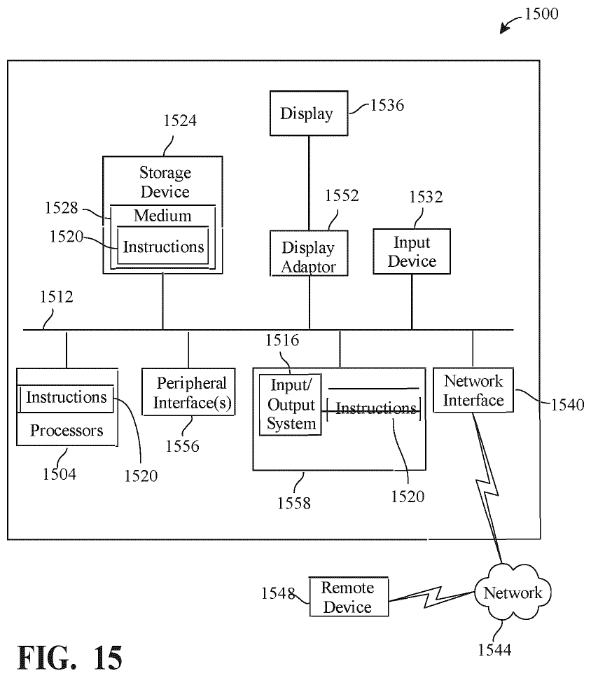

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 13124 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display device 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A system for processing electronic communications, the system comprising:
at least a server;
a data organizer operating on the at least one server, wherein the data organizer is designed and configured to:
categorize a plurality of tasks based on associated task data to one or more task categories;
a task identification module operating on the at least one server, wherein the task identification module is designed and configured to:
identify one or more automatable tasks for each one of the one or more task categories using a task identifying machine-learning model trained with task identification training data, wherein the task identification training data comprises exemplary tasks correlated to exemplary automatable tasks; and
a task execution module operating on the at least a server, wherein the task execution module is designed and configured to:
execute the one or more automatable tasks as a function of the one or more task categories.

2. The system of claim 1, wherein the data organizer is further configured to distribute each of the one or more automatable tasks to at least one task executing machine-learning model of the plurality of task executing machine-learning models as a function of the one or more task categories.

3. The system of claim 1, wherein the data organizer is further configured to:
load the one or more automatable tasks in a priority queue; and
distribute each of the one or more automatable tasks to one task executing machine-learning model of the plurality of task executing machine-learning models as a function of the priority queue.

4. The system of claim 1, wherein each one of the one or more automatable tasks comprises at least a portion of each task of the plurality of tasks that can be automatically executed.

5. The system of claim 1, wherein executing the one or more automatable tasks comprises:
generating a data prompt as a function the plurality of tasks, wherein the data prompt is configured to request additional data related to the plurality of tasks to a user;
transmitting the data prompt to a user device; and
executing the one or more automatable tasks as a function of the additional data received from the user.

6. The system of claim 1, wherein the task execution module comprises a plurality of task executing machine-learning models trained with execution training data, wherein:
each of the plurality of task executing machine-learning models is configured to execute a different executable task associated with a specific task category; and
the execution training data comprises historical execution data.

7. The system of claim 1, wherein the task execution module comprises a feedback mechanism, wherein the feedback mechanism is designed and configured to:
receive an execution outcome datum; and
refine the plurality of task executing machine-learning models as a function of evaluations of the execution outcome datum.

8. The system of claim 7, wherein the execution outcome datum further comprises a performance metric.

9. The system of claim 1, wherein the data organizer is further configured to:
receive a conversational response from a user device associated with at least a user; and
identify, using a language processing module, at least a request for a task performance as a function of the conversational response, wherein the at least a request for a task performance is associated with the plurality of tasks.

10. The system of claim 1, wherein the task execution module is further configured to:
generate a notification datum as a function of the execution of the one or more automatable tasks; and
transmit the notification datum to a user device.

11. A method for processing electronic communications, the method comprising:
receiving, from at least a server, a plurality of tasks;
categorizing, using a data organizer operating on the at least one server, the plurality of tasks to one or more task categories;
identifying, using a task identification module operating on the at least one server, one or more automatable tasks for each one of the one or more task categories using a task identifying machine-learning model trained with task identification training data, wherein the task identification training data comprises exemplary tasks correlated to exemplary automatable tasks; and
executing, using a task execution module operating on the at least one server, the one or more automatable tasks as a function of the one or more task categories.

12. The method of claim 11, further comprising:
distributing, using the data organizer, each of the one or more automatable tasks to at least one task executing machine-learning model of the plurality of task executing machine-learning models as a function of the one or more task categories.

13. The method of claim 11, further comprising:
loading, using the data organizer, the one or more automatable tasks in a priority queue; and
distributing, using the data organizer, each of the one or more automatable tasks to one task executing machine-learning model of the plurality of task executing machine-learning models as a function of the priority queue.

14. The method of claim 11, wherein each one of the one or more automatable tasks comprises at least a portion of each task of the plurality of tasks that can be automatically executed.

15. The method of claim 11, wherein executing the one or more automatable tasks comprises:
generating a data prompt as a function the plurality of tasks, wherein the data prompt is configured to request additional data related to the plurality of tasks to a user;
transmitting the data prompt to a user device; and
executing the one or more automatable tasks as a function of the additional data received from the user.

16. The method of claim 11, wherein the task execution module comprises a plurality of task executing machine-learning models trained with execution training data, wherein:
each of the plurality of task executing machine-learning models is configured to execute a different executable task associated with a specific task category; and
the execution training data comprises historical execution data.

17. The method of claim 11, further comprising:
receiving, using a feedback mechanism of the task execution module, an execution outcome datum; and
refining, using the feedback mechanism, the plurality of task executing machine-learning models as a function of evaluations of the execution outcome datum.

18. The method of claim 17, wherein the execution outcome datum further comprises a performance metric.

19. The method of claim 11, further comprising:
receiving, using the data organizer, a conversational response from a user device associated with at least a user; and
identifying, using a language processing module and the data organizer, at least a request for a task performance as a function of the conversational response, wherein the at least a request for a task performance is associated with the plurality of tasks.

20. The method of claim 11, further comprising:
generating, using the task execution module, a notification datum as a function of the execution of the one or more automatable tasks; and
transmitting, using the task execution module, the notification datum to a user device.
